(19) United States
(12) Patent Application Publication
(10) Pub. No.: US 2025/0317264 A1
(43) Pub. Date: Oct. 9, 2025

(54) TECHNIQUES FOR REPORTING OF MEASURED SYNCHRONIZATION SIGNAL BLOCK (SSB) FOR SUB-BAND FULL-DUPLEX (SBFD) OPERATION

(71) Applicant: QUALCOMM Incorporated, San Diego, CA (US)

(72) Inventors: Muhammad Sayed Khairy ABDELGHAFFAR, San Jose, CA (US); Jae Ho RYU, San Diego, CA (US); Prashant SHARMA, San Marcos, CA (US); Abdelrahman Mohamed IBRAHIM, San Diego, CA (US)

(21) Appl. No.: 19/078,710

(22) Filed: Mar. 13, 2025

Related U.S. Application Data
(60) Provisional application No. 63/573,739, filed on Apr. 3, 2024.

(51) Int. Cl. H04L 5/14; H04W 24/10; H04W 72/0446

(52) U.S. Cl. CPC H04L 5/14; H04W 24/10; H04W 72/0446

(57) ABSTRACT

Methods, systems, and devices for wireless communications are described. A user equipment (UE) may receive a first control message indicating a sub-band full-duplex (SBFD) pattern for SBFD symbols, where the SBFD pattern indicates one or more uplink sub-bands for the SBFD symbols and one or more downlink sub-bands for the SBFD symbols. The UE may receive a second control message scheduling multiple synchronization signal blocks (SSBs), associated with multiple SSB bursts, via multiple SBFD symbols. The UE may transmit a report indicating one or more SSB bursts, from the multiple SSB bursts, that each include one or more SSBs to be measured by the UE. In such cases, uplink communications may be restricted during one or more first SBFD symbols associated with each of the one or more SBFD bursts based on the one or more SBFD symbols including the one or more SSBs to be measured by the UE.

### CROSS REFERENCES

The present Application for Patent claims benefit of U.S. Provisional Patent Application No. 63/573,739 by ABDELGHAFFAR et al., entitled “TECHNIQUES FOR REPORTING OF MEASURED SYNCHRONIZATION SIGNAL BLOCK (SSB) FOR SUB-BAND FULL-DUPLEX (SBFD) OPERATION,” filed Apr. 3, 2024, assigned to the assignee hereof, and expressly incorporated herein.

### FIELD OF TECHNOLOGY

The following relates to wireless communications, including techniques for reporting of measured synchronization signal block (SSB) for sub-band full-duplex (SBFD) operation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for reporting of measured synchronization signal block (SSB) for sub-band full-duplex (SBFD) operation. Generally, techniques described herein may enable a user equipment (UE) to report one or more SSBs to be measured by the UE, such that scheduling of uplink communications via one or more SBFD symbols associated with the one or more SSBs may be restricted. For example, a UE may receive a first control message indicating an SBFD pattern for one or more SBFD symbols, where the SBFD pattern indicates one or more uplink sub-bands for the one or more SBFD symbols and one or more downlink sub-bands for the one or more SBFD symbols. Additionally, the UE may receive a second control message scheduling multiple SSBs via multiple SBFD symbols (e.g., via the one or more downlink sub-bands associated with each of the multiple SBFD symbols). In such cases, the multiple SSBs may be associated with (e.g., transmitted via) multiple SSB bursts. The UE may transmit a report indicating one or more SSB bursts, from the multiple SSB bursts, that each include one or more SSBs to be measured by the UE. In such cases, scheduling of uplink communications may be restricted during one or more first SBFD symbols associated with each of the one or more SSB bursts based on the one or more first SBFD symbols including (e.g., being used to transmit) the one or more SSBs to be measured by the UE. Additionally, in some cases, the report may indicate the one or more SSBs, from the one or more SSB bursts, to be measured by the UE, may indicate one or more second SSBs, from the one or more SSB bursts, not to be measured by the UE, or both. In such cases, scheduling of uplink communications may be unrestricted during one or more second SBFD symbols associated with each of the one or more SSB bursts based on the one or more second SBFD symbols including (e.g., being used to transmit) the one or more second SSBs not to be measured by the UE.

A method for wireless communications by a UE is described. The method may include receiving a first control message indicating a SBFD pattern for SBFD symbols, where the SBFD pattern indicates one or more uplink sub-bands for the SBFD symbols and one or more downlink sub-bands for the SBFD symbols, receiving a second control message scheduling a set of multiple SSBs via a set of multiple SBFD symbols, where the set of multiple SSBs are associated with a set of multiple SSB bursts, and transmitting a report indicating one or more SSB bursts, from the set of multiple SSB bursts, that each include one or more SSBs to be measured by the UE, where uplink communications are restricted during one or more first SBFD symbols associated with each of the one or more SSB bursts based on the one or more first SBFD symbols including the one or more SSBs to be measured by the UE.

A UE for wireless communications is described. The UE may include one or more memories storing processor executable code, and one or more processors coupled with the one or more memories. The one or more processors may individually or collectively be operable to execute the code to cause the UE to receive a first control message indicating a SBFD pattern for SBFD symbols, where the SBFD pattern indicates one or more uplink sub-bands for the SBFD symbols and one or more downlink sub-bands for the SBFD symbols, receive a second control message scheduling a set of multiple SSBs via a set of multiple SBFD symbols, where the set of multiple SSBs are associated with a set of multiple SSB bursts, and transmit a report indicating one or more SSB bursts, from the set of multiple SSB bursts, that each include one or more SSBs to be measured by the UE, where uplink communications are restricted during one or more first SBFD symbols associated with each of the one or more SSB bursts based on the one or more first SBFD symbols including the one or more SSBs to be measured by the UE.

Another UE for wireless communications is described. The UE may include means for receiving a first control message indicating a SBFD pattern for SBFD symbols, where the SBFD pattern indicates one or more uplink sub-bands for the SBFD symbols and one or more downlink sub-bands for the SBFD symbols, means for receiving a second control message scheduling a set of multiple SSBs via a set of multiple SBFD symbols, where the set of multiple SSBs are associated with a set of multiple SSB bursts, and means for transmitting a report indicating one or more SSB bursts, from the set of multiple SSB bursts, that each include one or more SSBs to be measured by the UE, where uplink communications are restricted during one or more first SBFD symbols associated with each of the one or more SSB bursts based on the one or more first SBFD symbols including the one or more SSBs to be measured by the UE.

A non-transitory computer-readable medium storing code for wireless communications is described. The code may include instructions executable by one or more processors to receive a first control message indicating a SBFD pattern for SBFD symbols, where the SBFD pattern indicates one or more uplink sub-bands for the SBFD symbols and one or more downlink sub-bands for the SBFD symbols, receive a second control message scheduling a set of multiple SSBs via a set of multiple SBFD symbols, where the set of multiple SSBs are associated with a set of multiple SSB bursts, and transmit a report indicating one or more SSB bursts, from the set of multiple SSB bursts, that each include one or more SSBs to be measured by the UE, where uplink communications are restricted during one or more first SBFD symbols associated with each of the one or more SSB bursts based on the one or more first SBFD symbols including the one or more SSBs to be measured by the UE.

In some examples of the method, UEs, and non-transitory computer-readable medium described herein, the report includes a bitmap indicating the one or more SSB bursts from the set of multiple SSB bursts.

In some examples of the method, UEs, and non-transitory computer-readable medium described herein, the report includes an indication of a periodicity associated with the one or more SSB bursts.

In some examples of the method, UEs, and non-transitory computer-readable medium described herein, the report includes an indication of a window defined by a slot offset and a duration and the window includes the one or more SSB bursts.

In some examples of the method, UEs, and non-transitory computer-readable medium described herein, the report further indicates a periodicity associated with the window.

In some examples of the method, UEs, and non-transitory computer-readable medium described herein, transmitting the report may include operations, features, means, or instructions for transmitting an indication of the one or more SSBs to be measured by the UE during each of the one or more SSB bursts, where restricting uplink communication during the one or more first SBFD symbols may be based on indicating the one or more SSBs to be measured by the UE.

In some examples of the method, UEs, and non-transitory computer-readable medium described herein, the report may be transmitted via UCI, a CSI report, a MAC-CE, UAI, or any combination thereof.

In some examples of the method, UEs, and non-transitory computer-readable medium described herein, the report may be transmitted aperiodically, periodically, persistently, semi-persistently, or any combination thereof.

In some examples of the method, UEs, and non-transitory computer-readable medium described herein, the report may be transmitted based on a change in the one or more SSBs to be measured by the UE.

Some examples of the method, UEs, and non-transitory computer-readable medium described herein may further include operations, features, means, or instructions for initiating a timer based on transmission of the report, where uplink communications may be restricted during all SBFD symbols based on expiration of the timer.

In some examples of the method, UEs, and non-transitory computer-readable medium described herein, transmitting the report may include operations, features, means, or instructions for transmitting an indication of one or more second SSBs not to be measured by the UE during each of the one or more SSB bursts, where restricting uplink communication during the one or more first SBFD symbols including the one or more SSBs to be measured by the UE may be based on indicating the one or more second SSBs not to be measured by the UE.

In some examples of the method, UEs, and non-transitory computer-readable medium described herein, the report may be transmitted via UCI, a CSI report, a MAC-CE, UAI, or any combination thereof.

In some examples of the method, UEs, and non-transitory computer-readable medium described herein, the report may be transmitted aperiodically, periodically, persistently, semi-persistently, or any combination thereof.

In some examples of the method, UEs, and non-transitory computer-readable medium described herein, the report may be transmitted based on a change in the one or more SSBs to be measured by the UE.

Some examples of the method, UEs, and non-transitory computer-readable medium described herein may further include operations, features, means, or instructions for initiating a timer based on transmission of the report, where uplink communications may be restricted during all SBFD symbols based on expiration of the timer.

Some examples of the method, UEs, and non-transitory computer-readable medium described herein may further include operations, features, means, or instructions for monitoring for the one or more SSBs via the one or more first SBFD symbols based on transmitting the report.

Some examples of the method, UEs, and non-transitory computer-readable medium described herein may further include operations, features, means, or instructions for canceling uplink transmissions via the one or more first SBFD symbols based on monitoring for the one or more SSBs via the one or more first SBFD symbols.

Some examples of the method, UEs, and non-transitory computer-readable medium described herein may further include operations, features, means, or instructions for receiving a third control message scheduling uplink communications via one or more second SBFD symbols associated with the one or more SSB bursts based on the one or more second SBFD symbols including one or more second SSBs not to be measured by the UE.

Some examples of the method, UEs, and non-transitory computer-readable medium described herein may further include operations, features, means, or instructions for canceling measurement on the one or more second SSBs based on receiving the third control message.

In some examples of the method, UEs, and non-transitory computer-readable medium described herein, the UE restricts uplink communications during the one or more first SBFD symbols based on the report being transmitted a threshold duration prior to the one or more first SBFD symbols.

Some examples of the method, UEs, and non-transitory computer-readable medium described herein may further include operations, features, means, or instructions for transmitting a capability message that indicates a capability of the UE to be scheduled with uplink communications via a set of multiple SBFD symbols associated with the set of multiple SSBs.

In some examples of the method, UEs, and non-transitory computer-readable medium described herein, transmitting the capability message may include operations, features, means, or instructions for transmitting the capability message indicating a capability of the UE to report the one or more SSBs to be measured by the UE.

In some examples of the method, UEs, and non-transitory computer-readable medium described herein, transmitting the capability message may include operations, features, means, or instructions for transmitting the capability message indicating a capability of the UE to transmit uplink communications via the set of multiple SBFD symbols in accordance with configuration information received from a network entity.

In some examples of the method, UEs, and non-transitory computer-readable medium described herein, the one or more SSBs may be from a subset of the set of multiple SSBs and the subset of the set of multiple SSBs may be configured for measurements by the UE.

In some examples of the method, UEs, and non-transitory computer-readable medium described herein, the one or more SSBs may be received from a primary cell and uplink transmissions may be unrestricted via one or more SBFD symbols associated with one or more secondary cells.

A method for wireless communications by a network entity is described. The method may include transmitting a first control message indicating a SBFD pattern for SBFD symbols, where the SBFD pattern indicates one or more uplink sub-bands for the SBFD symbols and one or more downlink sub-bands for the SBFD symbols, transmitting a second control message scheduling a set of multiple SSBs via a set of multiple SBFD symbols, where the set of multiple SSBs are associated with a set of multiple SSB bursts, and receiving a report indicating one or more SSB bursts, from the set of multiple SSB bursts, that each include one or more SSBs to be measured by a UE, where uplink communications are restricted during one or more first SBFD symbols associated with each of the one or more SSB bursts based on the one or more first SBFD symbols including the one or more SSBs to be measured by the UE.

A network entity for wireless communications is described. The network entity may include one or more memories storing processor executable code, and one or more processors coupled with the one or more memories. The one or more processors may individually or collectively be operable to execute the code to cause the network entity to transmit a first control message indicating a SBFD pattern for SBFD symbols, where the SBFD pattern indicates one or more uplink sub-bands for the SBFD symbols and one or more downlink sub-bands for the SBFD symbols, transmit a second control message scheduling a set of multiple SSBs via a set of multiple SBFD symbols, where the set of multiple SSBs are associated with a set of multiple SSB bursts, and receive a report indicating one or more SSB bursts, from the set of multiple SSB bursts, that each include one or more SSBs to be measured by a UE, where uplink communications are restricted during one or more first SBFD symbols associated with each of the one or more SSB bursts based on the one or more first SBFD symbols including the one or more SSBs to be measured by the UE.

Another network entity for wireless communications is described. The network entity may include means for transmitting a first control message indicating a SBFD pattern for SBFD symbols, where the SBFD pattern indicates one or more uplink sub-bands for the SBFD symbols and one or more downlink sub-bands for the SBFD symbols, means for transmitting a second control message scheduling a set of multiple SSBs via a set of multiple SBFD symbols, where the set of multiple SSBs are associated with a set of multiple SSB bursts, and means for receiving a report indicating one or more SSB bursts, from the set of multiple SSB bursts, that each include one or more SSBs to be measured by a UE, where uplink communications are restricted during one or more first SBFD symbols associated with each of the one or more SSB bursts based on the one or more first SBFD symbols including the one or more SSBs to be measured by the UE.

A non-transitory computer-readable medium storing code for wireless communications is described. The code may include instructions executable by one or more processors to transmit a first control message indicating a SBFD pattern for SBFD symbols, where the SBFD pattern indicates one or more uplink sub-bands for the SBFD symbols and one or more downlink sub-bands for the SBFD symbols, transmit a second control message scheduling a set of multiple SSBs via a set of multiple SBFD symbols, where the set of multiple SSBs are associated with a set of multiple SSB bursts, and receive a report indicating one or more SSB bursts, from the set of multiple SSB bursts, that each include one or more SSBs to be measured by a UE, where uplink communications are restricted during one or more first SBFD symbols associated with each of the one or more SSB bursts based on the one or more first SBFD symbols including the one or more SSBs to be measured by the UE.

In some examples of the method, network entities, and non-transitory computer-readable medium described herein, the report includes a bitmap indicating the one or more SSB bursts from the set of multiple SSB bursts.

In some examples of the method, network entities, and non-transitory computer-readable medium described herein, the report includes an indication of a periodicity associated with the one or more SSB bursts.

In some examples of the method, network entities, and non-transitory computer-readable medium described herein, the report includes an indication of a window defined by a slot offset and a duration and the window includes the one or more SSB bursts.

In some examples of the method, network entities, and non-transitory computer-readable medium described herein, the report further indicates a periodicity associated with the window.

In some examples of the method, network entities, and non-transitory computer-readable medium described herein, receiving the report may include operations, features, means, or instructions for receiving an indication of the one or more SSBs to be measured by the UE during each of the one or more SSB burst, where restricting uplink communication during the one or more first SBFD symbols may be based on indicating the one or more SSBs to be measured by the UE.

In some examples of the method, network entities, and non-transitory computer-readable medium described herein, the report may be received via UCI, a CSI report, a MAC-CE, UAI, or any combination thereof.

In some examples of the method, network entities, and non-transitory computer-readable medium described herein, the report may be received aperiodically, periodically, persistently, semi-persistently, or any combination thereof.

In some examples of the method, network entities, and non-transitory computer-readable medium described herein, the report may be received based on a change in the one or more SSBs to be measured by the UE.

Some examples of the method, network entities, and non-transitory computer-readable medium described herein may further include operations, features, means, or instructions for initiating a timer based on reception of the report, where uplink communications may be restricted during all SBFD symbols based on expiration of the timer.

In some examples of the method, network entities, and non-transitory computer-readable medium described herein, receiving the report may include operations, features, means, or instructions for receiving an indication of one or more second SSBs not to be measured by the UE during each of the one or more SSB bursts, where restricting uplink communication during the one or more first SBFD symbols including the one or more SSBs to be measured by the UE may be based on indicating the one or more second SSBs not to be measured by the UE.

In some examples of the method, network entities, and non-transitory computer-readable medium described herein, the report may be received via UCI, a CSI report, a MAC-CE, UAI, or any combination thereof.

In some examples of the method, network entities, and non-transitory computer-readable medium described herein, the report may be received aperiodically, periodically, persistently, semi-persistently, or any combination thereof.

In some examples of the method, network entities, and non-transitory computer-readable medium described herein, the report may be received based on a change in the one or more SSBs to be measured by the UE.

Some examples of the method, network entities, and non-transitory computer-readable medium described herein may further include operations, features, means, or instructions for initiating a timer based on reception of the report, where uplink communications may be restricted during all SBFD symbols based on expiration of the timer.

Some examples of the method, network entities, and non-transitory computer-readable medium described herein may further include operations, features, means, or instructions for refraining from scheduling uplink communications during the one or more first SBFD symbols based on uplink communications being restricted during the one or more first SBFD symbols.

Some examples of the method, network entities, and non-transitory computer-readable medium described herein may further include operations, features, means, or instructions for transmitting a third control message scheduling uplink communications via one or more second SBFD symbols associated with the one or more SSB bursts based on the one or more second SBFD symbols including one or more second SSBs not to be measured by the UE.

In some examples of the method, network entities, and non-transitory computer-readable medium described herein, the network entity restricts uplink communications during the one or more first SBFD symbols based on the report being received a threshold duration prior to the one or more first SBFD symbols.

Some examples of the method, network entities, and non-transitory computer-readable medium described herein may further include operations, features, means, or instructions for receiving a capability message that indicates a capability of the UE to be scheduled with uplink communications via a set of multiple SBFD symbols associated with the set of multiple SSBs.

In some examples of the method, network entities, and non-transitory computer-readable medium described herein, receiving the capability message may include operations, features, means, or instructions for receiving the capability message indicating a capability of the UE to report the one or more SSBs to be measured by the UE.

In some examples of the method, network entities, and non-transitory computer-readable medium described herein, receiving the capability message may include operations, features, means, or instructions for receiving the capability message indicating a capability of the UE to transmit uplink communications via the set of multiple SBFD symbols in accordance with configuration information transmitted by the network entity.

In some examples of the method, network entities, and non-transitory computer-readable medium described herein, the one or more SSBs may be from a subset of the set of multiple SSBs and the subset of the set of multiple SSBs may be configured for measurements by the UE.

In some examples of the method, network entities, and non-transitory computer-readable medium described herein, the network entity may be a primary cell and uplink transmissions may be unrestricted via one or more SBFD symbols associated with one or more secondary cells.

### BRIEF DESCRIPTION OF THE DRAWINGS

FIG. 1 shows an example of a wireless communications system that supports techniques for reporting of measured synchronization signal block (SSB) for sub-band full-duplex (SBFD) operation in accordance with one or more aspects of the present disclosure.

FIG. 2 shows an example of a wireless communications system that supports techniques for reporting of measured SSB for sub-band full-duplex operation in accordance with one or more aspects of the present disclosure.

FIG. 3 shows an example of a process flow that supports techniques for reporting of measured SSB for sub-band full-duplex operation in accordance with one or more aspects of the present disclosure.

FIGS. 4 and 5 show block diagrams of devices that support techniques for reporting of measured SSB for sub-band full-duplex operation in accordance with one or more aspects of the present disclosure.

FIG. 6 shows a block diagram of a communications manager that supports techniques for reporting of measured SSB for sub-band full-duplex operation in accordance with one or more aspects of the present disclosure.

FIG. 7 shows a diagram of a system including a device that supports techniques for reporting of measured SSB for sub-band full-duplex operation in accordance with one or more aspects of the present disclosure.

FIGS. 8 and 9 show block diagrams of devices that support techniques for reporting of measured SSB for sub-band full-duplex operation in accordance with one or more aspects of the present disclosure.

FIG. 10 shows a block diagram of a communications manager that supports techniques for reporting of measured SSB for sub-band full-duplex operation in accordance with one or more aspects of the present disclosure.

FIG. 11 shows a diagram of a system including a device that supports techniques for reporting of measured SSB for sub-band full-duplex operation in accordance with one or more aspects of the present disclosure.

FIGS. 12 and 13 show flowcharts illustrating methods that support techniques for reporting of measured SSB for sub-band full-duplex operation in accordance with one or more aspects of the present disclosure.

### DETAILED DESCRIPTION

In some wireless communications systems, a network entity may operate according to a sub-band full-duplex (SBFD) mode in which the network entity may simultaneously transmit and receive communications. In such cases, the network entity may configure one or more symbols of a user equipment (UE), which may be referred to as an SBFD-aware UE, in accordance with an SBFD pattern. That is, the network entity may configure the SBFD-aware UE with one or more SBFD symbols, where each SBFD symbol includes one or more uplink sub-bands (e.g., for uplink transmissions) and one or more downlink sub-bands (e.g., for downlink transmissions). As such the network entity may transmit downlink communications via the one or more downlink sub-bands of the SBFD symbols and may schedule uplink communications via the one or more uplink sub-bands of the SBFD symbols. However, in some cases, the uplink communications may cause interference with the downlink communications at a UE. For example, a first UE may transmit uplink communications via an uplink sub-band of an SBFD symbol (e.g., based on scheduling by the network entity) and the network entity may simultaneously transmit a synchronization signal block (SSB) to a second UE via one or more downlink sub-bands of the SBFD symbol, where the uplink communications cause interference with the SSB. Thus, measurements of the SSBs performed by the second UE may be inaccurate due to the interference. In some other scenarios, the SBFD-aware UE may be scheduled or configured with uplink communications via an uplink sub-band of an SBFD symbol that overlap with receipt of SSBs used by the SBFD-aware UE for measurements. This conflict may cause the UE to skip SSB measurement or cancel the uplink transmission.

Accordingly, techniques described herein may enable a UE (e.g., SBFD-aware UE) to report, to a network entity, one or more SSBs to be measured by the UE, such that uplink communications in SBFD symbols associated with the one or more SSBs may be restricted (e.g., disabled). For example, the UE may be scheduled with multiple SSBs (e.g., including the one or more SSBs) associated with multiple SSB bursts. In some cases, the multiple SSBs may be divided into SSBs to be measured by the UE, which may be referred to as protected SSBs, and SSBs not to be measured by the UE, which may be referred to as unprotected SSBs, in a time domain. In other words, a time mask may be applied to the multiple SSBs, such that the multiple SSB bursts may be divided into protected SSB bursts and unprotected SSB bursts. In some cases, uplink communications may be restricted during protected SSB bursts based on the protected SSB bursts including one or more protected SSBs and may be unrestricted during unprotected SSB bursts based on the unprotected SSB bursts including unprotected SSBs. Thus, the UE may transmit a report, to the network entity, indicating one or more protected SSB bursts (e.g., from the multiple SSB bursts), one or more unprotected SSB bursts (e.g., from the multiple SSB bursts), or both.

Additionally, or alternatively, the multiple SSBs may be divided into protected SSBs and unprotected SSBs in a spatial domain. In other words, a spatial mask may be applied to multiple SSBs in an SSB burst, such that the multiple SSBs in the SSB burst may be divided into protected SSBs and unprotected SSBs (e.g., regardless of whether the SSBs are from a protected SSB burst or an unprotected SSB burst). In such cases, uplink communications may be restricted during protected SSBs based on the protected SSBs being used for measurements by the UE and may be unrestricted in unprotected SSBs based on the unprotected SSBs not being used for measurements by the UE. Thus, the UE may additionally, or alternatively, transmit the report indicating one or more protected SSBs (e.g., from the multiple SSBs), one or more unprotected SSBs (e.g., from the multiple SSBs), or both. For example, the UE may transmit the report indicating the one or more protected SSB bursts and which SSBs from each protected SSB burst are unprotected SSBs. Additionally, or alternatively, the UE may transmit the report indicating the one or more unprotected SSB bursts and which SSBs from each unprotected SSB burst are protected SSBs. Conversely, the UE may refrain from indicating the one or more protected SSB bursts, the one or more unprotected SSB bursts, or both, and may instead indicate the one or more protected SSBs, the one or more unprotected SSBs, or both (e.g., without an indication of the one or more protected SSB bursts, the one or more unprotected SSB bursts, or both).

Aspects of the disclosure are initially described in the context of wireless communications systems. Aspects are then described in the context of Aspects of the disclosure are further illustrated by and described herein with reference to apparatus diagrams, system diagrams, and flowcharts that relate to techniques for reporting of actual measured SSB for sub-band full-duplex operation.

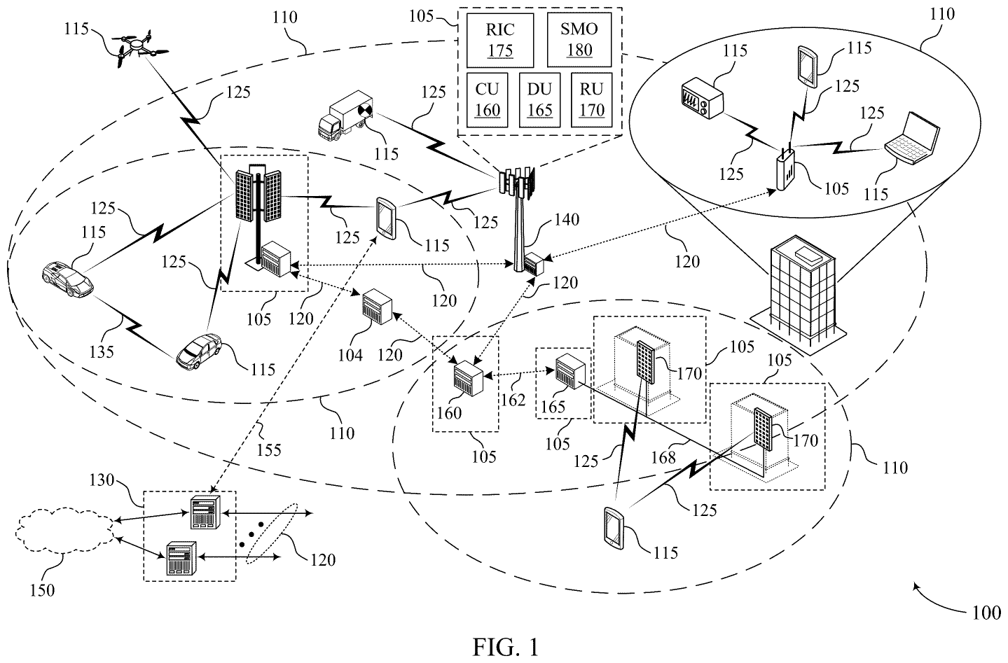

FIG. 1 shows an example of a wireless communications system 100 that supports techniques for reporting of measured SSB for sub-band full-duplex operation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, UEs 115 of the wireless communications system 200 may support beam reporting. In such cases, a same payload structure may be used for reporting on both physical uplink shared channel (PUSCH) and physical uplink control channel (PUCCH). In some cases, three payload designs may be defined as reference signal receive power (RSRP), signal interference and noise ratio (SINR), and group-based RSRP. In such cases, a similar structure may be used for both L1-RSRP And L1-SINR reporting. In some cases, for L1-RSRP reporting, if a higher layer parameter nrofReportedRS in CSI-ReportConfig is configured to be one and a reported L1-RSRP value is defined by a 7-bit value in a range [−140,−44] dBM with a 1 dB step size, the UE 115 may use differential L1-RSRP based reporting, where a largest measured value of L1-RSRP is quantized to a 7-bit value in the range [−140,−44] dBM with a 1 dB step size, and a differential L1-RSRP may be quantized to a 4-bit value. In such cases, the differential L1-RSRP value may be computed with 2 dB step size with a reference to a largest measured L1-RSRP value with is part of a same L1-RSRP reporting instance. The same may be true if the higher layer parameter nrofReportedRS in CSI-ReportConfig is configured to be one, or if a higher layer parameter groupBasedBeamReporting is configured as ‘enabled,’ or if a higher layer parameter groupBasedBeamReporting-r17 is configured.

In some cases, a network entity 105 of the wireless communications system 200 may transmit SSBs to UEs 115 of the wireless communications system 200. In such cases, the network entity 105 may transmit one or more SSB bursts, where each SSB burst includes multiple SSBs. However, in some cases, not all of the SSBs in the SSB bursts may be transmitted by the network entity 105. That is, some of the SSBs in the SSB bursts may be muted. As such, the network entity 105 may transmit, to a UE 115, control signaling (e.g., ServingCellConfigCommonSIB) indicating which SSBs are to be transmitted (e.g., which SSBs are available for measurement by the UE 115). For example, the network entity 105 may transmit a system information block (SIB) message (e.g., SIB1 message) indicating which SSBs are to be transmitted (e.g., via ssb-PositionInBurst in the SIB1 message). Additionally, or alternatively, the network entity 105 may transmit configuration information (e.g., ServingCellConfigCommon) indicating which SSBs are to be transmitted. In such cases, the configuration information may be used to configure cell-specific parameters of a serving cell (e.g., SCell) of the UE 115.

In such cases, the SSBs transmitted by the network entity 105 (e.g., SSBs of the serving cell, indicated by ssb-PositionInBurst) may be used by the UE 115 for measurement procedures. For example, the UE 115 may perform SSB-based radio resource management (RRM) measurements based on the SSBs. In such cases, the SSB-based RRM may be configured via an SSB Measurement Timing Configuration (SMTC) (e.g., for a serving cell or neighbor cell). In such cases, the SMTC may be associated with an SMTC periodicity (e.g., {5 ms, 10 ms, 20 ms, 40 ms, 80 ms, 160 ms}), an SMTC window duration (e.g., {1 ms, 2 ms, 3 ms, 4 ms, 5 ms}), an offset (e.g., offset= {0, 1, . . . SMTC periodicity-1}), or any combination thereof. Thus, in an idle mode, the UE 115 may measure SSBs (e.g., all SSBs) within the SMTC window. In such cases, the UE 115 may not receive an indication of a set of SSBs within the SMTC window to measure. Additionally, a single SMTC may be configured per frequency carrier. Conversely, in a connected mode, the network entity 105 may transmit an indication of a set of SSBs within the SMTC window to measure. For example, the network entity may transmit a control message (e.g., radio resource control (RRC) signaling) indicating a bitmap (e.g., ssb-To-Measure) indicating the set of SSBs. In such cases, the bitmap may be applicable for both intra-frequency and inter-frequency measurements. Additionally, or alternatively, if the indication is absent (e.g., the UE 115 does not receive the indication in a connected mode), the UE 115 may measure all SSBs within the SMTC window. Additionally, or alternatively, up to two SMTCs may be configured for intra-frequency measurements and one SMTC may be configured for inter-frequency measurements. In either case (e.g., idle mode or connected mode), the UE 115 may measure one or more metrics associated with the SSBs, including, but not limited to, SS-RSRP, SS-reference signal receive quality (SS-RSRQ), SS-SINR, received signal strength indicator (RSSI), or any combination thereof.

In some cases, the wireless communications system 200 may support techniques described to enable a UE 115 (e.g., SBFD-aware UE 115) to report, to a network entity, one or more SSBs to be measured by the UE 115, such that uplink communications in SBFD symbols associated with the one or more SSBs may be restricted (e.g., disabled). For example, the UE 115 may be scheduled with multiple SSBs (e.g., including the one or more SSBs) associated with multiple SSB bursts. In some cases, the multiple SSBs may be divided into SSBs to be measured by the UE 115, which may be referred to as protected SSBs, and SSBs not to be measured by the UE 115, which may be referred to as unprotected SSBs, in a time domain. In other words, a time mask may be applied to the multiple SSBs, such that the multiple SSB bursts may be divided into protected SSB bursts and unprotected SSB bursts. In some cases, uplink communications may be restricted during protected SSB bursts based on the protected SSB bursts including one or more protected SSBs and may be unrestricted during unprotected SSB bursts based on the unprotected SSB bursts including unprotected SSBs. Thus, the UE 115 may transmit a report, to the network entity, indicating one or more protected SSB bursts (e.g., from the multiple SSB bursts), one or more unprotected SSB bursts (e.g., from the multiple SSB bursts), or both.

Additionally, or alternatively, the multiple SSBs may be divided into protected SSBs and unprotected SSBs in a spatial domain. In other words, a spatial mask may be applied to the multiple SSBs, such that the multiple SSBs may be divided into protected SSBs and unprotected SSBs (e.g., regardless of whether the SSBs are from a protected SSB burst or an unprotected SSB burst). In such cases, uplink communications may be restricted during protected SSBs based on the protected SSBs being used for measurements by the UE 115 and may be unrestricted in unprotected SSBs based on the unprotected SSBs not being used for measurements by the UE 115. Thus, the UE 115 may additionally, or alternatively, transmit the report indicating one or more protected SSBs (e.g., from the multiple SSBs), one or more unprotected SSBs (e.g., from the multiple SSBs), or both. For example, the UE 115 may transmit the report indicating the one or more protected SSB bursts and which SSBs from each protected SSB burst are unprotected SSBs. Additionally, or alternatively, the UE 115 may transmit the report indicating the one or more unprotected SSB bursts and which SSBs from each unprotected SSB burst are protected SSBs. Conversely, the UE 115 may refrain from indicating the one or more protected SSB bursts, the one or more unprotected SSB bursts, or both, and may instead indicate the one or more protected SSBs, the one or more unprotected SSBs, or both (e.g., without an indication of the one or more protected SSB bursts, the one or more unprotected SSB bursts, or both).

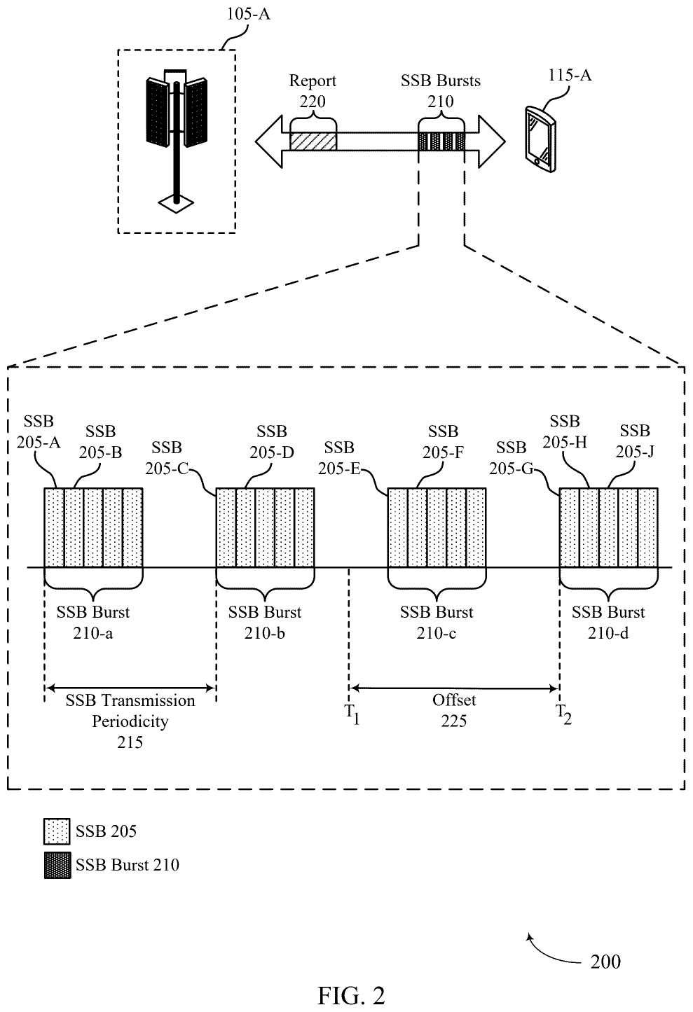

FIG. 2 shows an example of a wireless communications system 200 that supports techniques for reporting of measured SSB for sub-band full-duplex operation in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115a) and one or more network entities 105 (e.g., a network entity 105 a), which may be examples of the corresponding devices as described herein.

In some wireless communications systems, a network entity 105-a may operate according to an SBFD mode in which the network entity 105-a may simultaneously transmit downlink communications (e.g., signaling) and receive uplink communications. In such cases, the network entity 105-a may configure one or more symbols of a UE 115-a in accordance with an SBFD pattern. That is, the network entity 105-a may transmit, to the UE 115-a, control signaling (e.g., one or more control messages) indicating configuration information associated with the SBFD pattern, where the configuration information indicates one or more SBFD symbols and, for each SBFD symbol of the one or more SBFD symbols, an uplink sub-band (e.g., one or more uplink sub-bands) of the SBFD symbol (e.g., for uplink transmissions) and one or more downlink sub-bands of the SBFD symbol (e.g., for downlink transmissions). In some cases, the UE 115-a may be a half-duplex UE 115-a (e.g., SBFD-aware UE 115-a), such that the UE 115-a may not be capable of simultaneously receiving downlink communications and transmitting uplink communications in an SBFD symbol.

However, in some cases, the network entity 105-a may transmit downlink communications (e.g., to the UE 115-a) via the one or more downlink sub-bands of an SBFD symbol and may schedule uplink communications (e.g., by another UE 115) via the uplink sub-band of the SBFD symbol. In such cases, collisions may exist between the downlink communications received by the UE 115-a (e.g., downlink reception) in the one or more downlink sub-bands and the uplink communications transmitted by the other UE 115 (e.g., uplink transmission based on the scheduling) in the uplink sub-band. Additionally, or alternatively, collisions may occur between downlink communications received by the UE 115-a in a first SBFD symbol and uplink communications transmitted by the UE 115-a in a second SBFD symbol based on lack of a threshold (e.g., sufficient) transition duration between reception and transmission (e.g., or visa-versa) at the UE 115-a.

For example, dynamically scheduled downlink communications (e.g., dynamic physical downlink shared channel (PDSCH) or channel state information-reference signal (CSI-RS)) may collide with semi-statically configured uplink communications (e.g., sounding reference signal (SRS,), PUSCH, or configured grant (CG)-PUSCH). Additionally, or alternatively, semi-statically configured downlink communications (e.g., PDSCH or semi-persistent scheduling (SPS) PDSCH) may collide with dynamically scheduled uplink communications (e.g., dynamic PUSCH or PUCCH). Additionally, or alternatively, semi-statically configured downlink communications may collide with semi-statically configured uplink communications. Additionally, or alternatively, dynamically scheduled downlink communications may collide with dynamically scheduled uplink communications. Additionally, or alternatively, dynamically scheduled or semi-statically configured downlink communications may collide with a valid resource occasion (RO).

Of particular focus, in some cases, SSBs 205 (e.g., SSB reception) may collide with dynamically scheduled or configured (e.g., semi-statically) uplink communications (e.g., uplink transmission). For example, the network entity 105-a may transmit, to the UE 115-a, an SSB 205 via one or more downlink sub-bands of an SBFD symbol and may also schedule another UE 115 to transmit uplink communications (e.g., PUSCH, PUCCH, physical random access channel (PRACH), or SRS) via an uplink sub-band of the SBFD symbol, such that the uplink communications cause interference (e.g., inter-UE cross link interference (CLI)) with the SSB 205. Thus, measurements of the SSB 205 performed by the UE 115-a may be inaccurate due to the interference.

As such, in some cases, SSBs 205 may be protected (e.g., always) in SBFD symbols. That is, an SBFD symbol used to transmit an SSB 205 may be configured as an SSB symbol (e.g., symbol carrying SSB 205), where scheduling of uplink communications may be restricted in SSB symbols. However, an SSB transmission periodicity 215 (e.g., 50 ms, 10 ms, 20 ms, 40 ms, 80 ms, or 160 ms) may not align with an SBFD-pattern, such that an SBFD symbol may not be configured as an SSB symbol and, thus, may not be associated with restricted uplink communications, however, an SSB 205 may be transmitted at least partially during the SBFD symbol, such that the SSB 205 may experience interference due to uplink communications scheduled during the SBFD symbol.

Accordingly, techniques described herein may enable a UE 115 (e.g., SBFD-aware UE 115), such as a UE 115-a, to report, to a network entity 105, such as a network entity 105-a, one or more SSBs 205 (e.g., SSB indices) to be measured by the UE 115-a, such that uplink communications in SBFD symbols associated with the one or more SSBs 205 may be restricted (e.g., disabled). That is, techniques described herein may support flexibility to allow (e.g., enable) or disallow (e.g., restrict) SBFD operations in one or more SBFD symbols based on the one or more SBFD symbols being used for transmission of SSBs 205 (e.g., based on the one or more SBFD symbols being SSB symbols).

For example, as described previously, the UE 115-a (e.g., half-duplex UE 115, SBFD-aware UE 115) may receive a first control message indicating configuration information associated with an SBFD pattern for one or more SBFD symbols, where the SBFD pattern indicates, for each SBFD symbol, one more uplink sub-band (e.g., for uplink transmissions) and one or more downlink sub-bands (e.g., for downlink transmissions). Additionally, the UE 115-a may receive a second control message scheduling multiple SSBs 205 via multiple SBFD symbols. As described previously, an SBFD symbol scheduled with (e.g., used to transmit, used to receive) an SSB 205 may also be referred to as an SSB symbol. Additionally, the multiple SSBs 205 may be associated with multiple SSB bursts 210. That is, each SSB burst 210 of the multiple SSB bursts 210 may include multiple SSBs 205.

In some cases, the multiple SSBs 205 may be divided in a time domain. In such cases, the multiple SSB bursts 210 may be divided into two sets: protected SSB bursts 210 and unprotected SSB bursts 210. In some cases (e.g., when only divided in the time domain), protected SSB bursts 210 may be SSB bursts 210 to be used for measurements by the UE 115-a (e.g., including one or more SSBs 205 to be measured by the UE 115-a) and unprotected SSB bursts 210 may be SSB bursts 210 not to be used for measurements by the UE 115-a (e.g., not including one or more SSBs 205 to be measured by the UE 115-a). Thus, scheduling of uplink communications (e.g., transmissions) may be restricted (e.g., disallowed, disabled) during SBFD symbols associated with the protected SSB bursts 210. Conversely, scheduling of uplink communications may be unrestricted (e.g., allowed, enabled) during SBFD symbols associated with the unprotected SSB bursts 210. In some other cases, as described later in further detail, restrictions on the scheduling of uplink communications in protected SSB bursts vs. unprotected SSB bursts may be based on application of one or more spatial masks.

Thus, the UE 115-a may transmit a report 220 indicating one or more protected SSB bursts 210 (e.g., protected SSB burst indices) from the multiple SSB bursts 210 scheduled for the UE 115-a, one or more unprotected SSB bursts 210 (e.g., unprotected SSB burst indices) from the multiple SSB bursts 210 scheduled for the UE 115-a, or both. That is, the UE 115-a may indicate a first time mask for the one or more protected SSB bursts 210, a second time mask for the one or more unprotected SSBs 205, or both. For example, the UE 115-a may transmit a report 220 indicating that an SSB burst 210-a and an SSB burst 210-b are protected SSB bursts 210, that an SSB burst 210-c and an SSB burst 210-d are unprotected SSB bursts 210, or both.

In such cases, the report 220 may indicate the one or more protected SSB bursts 210, the one or more unprotected SSB bursts 210, or both, via a bitmap (e.g., SSB burst bitmap). For example, a bit value of 1 may represent a protected SSB burst 210 (e.g., used for measurement) and a bit value of 0 may represent an unprotected SSB burst 210, such that a bitmap of 1110 may indicate that the SSB burst 210-a, the SSB burst 210-b, and the SSB burst 210-c are protected SSB bursts 210 and the SSB burst 210-d is an unprotected SSB burst 210 (e.g., three SSB bursts 210 out of four SSB bursts 210 may be used by the UE 115-a for measurement). Additionally, or alternatively, the report 220 may indicate the one or more protected SSB bursts 210, the one or more unprotected SSB bursts 210, or both, based on an SSB burst decimation further based on a factor. For example, the report 220 may indicate that one out of a quantity, N, of SSB bursts 210 are protected SSB bursts 210, such that the decimation is 1:N. Additionally, or alternatively, the report 220 may indicate the one or more protected SSB bursts 210, the one or more unprotected SSB bursts 210, or both, based on a window. That is, the report 220 may indicate a periodicity of the window, a slot offset associated with the window, a duration of the window, or any combination thereof. For example, the report 220 may indicate a first window that includes the one or more protected SSB bursts 210, a second window that includes the one or more unprotected SSB bursts 210, or both.

In some cases, the one or more SSB bursts 210 reported by the UE 115-a (e.g., the one or more protected SSB bursts 210, the one or more unprotected SSB bursts 210, or both) may be based on a type of measurement associated with SSBs 205 of the one or more SSB bursts 210. That is, SSBs 205 may be used for different SSB measurements, including, but not limited to, RRM measurements, radio link monitoring (RLM) measurements, beam failure detection (BFD) measurements, handover measurements, or any combination thereof. Additionally, the different SSB measurements may be associated with a different quantity of SSB bursts 210 associated with performing the respective SSB measurements. That is, the UE 115-a may utilize the respective quantity of SSB bursts 210 (e.g., quantity of SSBs 205) to perform a given SSB measurement and may use a roaming time budget to run one or more associated algorithms. Thus, the UE 115-a may indicate (e.g., via a time mask) which SSB bursts 210 of the multiple SSB bursts 210 configured for the UE 115-a are protected SSB bursts 210 and which are unprotected SSB bursts 210. For example, for a given SSB measurement, the multiple SSB bursts 210 configured for the UE 115-a may include ten SSB bursts 210 (e.g., based on predefined requirements) but the UE 115-a may use four SSB bursts 210 for the given SSB measurements, such that the other six SSB bursts may not be used by the UE 115-a and may be indicated as unprotected SSBs 205. Thus, for each of the different SSB measurements, the UE 115-a may report one or more protected SSBs 205 used by the UE 115-a to perform a given SSB measurement. In some cases, some triggering events (e.g., SSBs 205 for RLM measurements, SSBs 205 for BFD measurements) may be associated with protected SSB bursts 210 (e.g., prioritizing SSB measurements in case of a handover, RLF, or BFD event). Additionally, or alternatively, the UE 115-a may report a relaxation factor. For example, a relaxation factor of two may indicate that the network entity 105-a may schedule uplink communications during alternate SMTC or SSB occasions.

Additionally, or alternatively, the multiple SSBs 205 may be divided in a spatial domain (e.g., according to one or more spatial masks). In such cased, the multiple SSBs 205 may be divided into two sets: protected SSBs 205 (e.g., protected SSB indices) and unprotected SSBs 205 (e.g., unprotected SSB indices). Protected SSBs 205 may be SSBs 205 that are to be measured by the UE 115-a, such that scheduling of uplink communications may be restricted during SBFD symbols associated with the protected SSBs 205. Conversely, unprotected SSBs 205 may be SSBs 205 that are not to be measured by the UE 115-a, such that scheduling of uplink communications may be unrestricted (e.g., allowed, enabled) during SBFD symbols associated with the unprotected SSBs 205. In such cases, the division of the multiple SSBs 205 may be regardless of whether each of the multiple SSBs 205 is from a protected SSB burst 210 or an unprotected SSB burst 210.

For example, in some cases, a first spatial mask may be applied to protected SSB bursts 210, such that each protected SSB burst 210 may include one or more protected SSBs 205 and one or more unprotected SSBs 205. As such, scheduling of uplink communications may be restricted during one or more first SBFD symbols of the protected SSB bursts 210 based on the one or more first SBFD symbols being associated with the one or more protected SSBs 205. Conversely, scheduling of uplink communications may be unrestricted during the one or more second SBFD symbols of the protected SSB bursts 210 based on the one or more second SBFD symbols being associated with the one or more unprotected SSBs 205. Additionally, in such cases (e.g., when the spatial mask is applied to protected SSB bursts 210), SBFD symbols (e.g., all SBFD symbols) associated with unprotected SSB bursts 210 may be used for scheduling of uplink communications.

Additionally, or alternatively, a second spatial mask may be applied to unprotected SSB bursts 210, such that each unprotected SSB burst 210 may include one or more protected SSBs 205 and one or more unprotected SSBs 205. As such, scheduling of uplink communications may be restricted during one or more first SBFD symbols of the unprotected SSB bursts 210 based on the one or more first SBFD symbols being associated with the one or more protected SSBs 205. Conversely, scheduling of uplink communications may be unrestricted during the one or more second SBFD symbols of the unprotected SSB bursts 210 based on the one or more second SBFD symbols being associated with the one or more unprotected SSBs 205. Additionally, in such cases (e.g., when the spatial mask is applied to unprotected SSB bursts 210), SBFD symbols (e.g., all SBFD symbols) associated with protected SSB bursts 210 may not be used (e.g., may be restricted) for scheduling of uplink communications.

As such, the report 220 may additionally, or alternatively, indicate one or more (e.g., a group of) protected SSBs 205 from the multiple SSBs 205 configured for the UE 115-a, one or more unprotected SSBs 205 from the multiple SSBs 205 configured for the UE 115-a, or both. For example, when the first spatial mask is applied to protected SSB bursts 210, the report 220 may indicate which SSBs 205 of the protected SSB bursts 210 are unprotected SSBs 205 and, thus, are available for scheduling of uplink communications. As an illustrative example, the report 220 may indicate that the SSB burst 210-a, the SSB burst 210-b, and the SSB burst 210-c are protected SSB bursts 210 and may further indicate that a first two SSBs 205 of each protected SSB burst 210 are unprotected SSBs 205. That is, an SSB 205-a and an SSB 205-b of the SSB burst 210-a, an SSB 205-c and an SSB 205-d of the SSB burst 210-b, and an SSB 205-e and an SSB 205-f of the SSB burst 210-c may be unprotected SSBs 205 and may be used for uplink communications (e.g., may not be restricted for scheduling of uplink communications). Thus, other SSBs 205 of the protected SSB bursts 210 may be protected SSBs 205 and may not be used for uplink communications (e.g., may be restricted for scheduling of uplink communications). Additionally, the SSB burst 210-d may be an unprotected SSB 205-d (e.g., as indicated by the report 220), such that the SSB burst 210-d includes unprotected SSBs 205 that are available for (e.g., unrestricted from) uplink communications.

Additionally, or alternatively, when the second spatial mask is applied to unprotected SSB bursts 210, the report 220 may indicate which SSBs 205 of the unprotected SSB bursts 210 are protected SSBs 205 and, thus, may not be used for scheduling of uplink communications. As an illustrative example, the report 220 may indicate that the SSB burst 210-a, the SSB burst 210-b, and the SSB burst 210-c are unprotected SSB bursts 210 and may further indicate that a first two SSBs 205 of each unprotected SSB burst 210 are protected SSBs 205. That is, the SSB 205-a and the SSB 205-b of the SSB burst 210-a, the SSB 205-c and the SSB 205-d of the SSB burst 210-b, and the SSB 205-e and the SSB 205-f of the SSB burst 210-c may be protected SSBs 205 and may not be used for uplink communications (e.g., may be restricted for scheduling of uplink communications). Thus, other SSBs 205 of the unprotected SSB bursts 210 may be unprotected SSBs 205 and may be used for uplink communications (e.g., may be unrestricted for scheduling of uplink communications). Additionally, the SSB burst 210-d may be a protected SSB 205-d (e.g., as indicated by the report 220), such that the SSB burst 210-d includes protected SSBs 205 that are no available for (e.g., restricted from) uplink communications.

Additionally, or alternatively, the report 220 may indicate which SSBs 205 of the multiple SSBs 205 are protected SSBs 205, which SSBs 205 of the multiple SSBs 205 are unprotected SSBs 205, or both (e.g., without an indication of the one or more protected SSB bursts 210, the one or more unprotected SSB bursts 210, or both).

In some cases, reporting of one or more protected SSBs 205, one or more unprotected SSBs 205, or both, may differ between UEs 115. For example, the UE 115-a may report that a first two SSBs 205 (e.g., SSB #0-1) of SSB bursts 210 are protected SSBs 205, such that a last three SSBs 205 (e.g., SSB #2, 3, 4) of the SSB bursts 210 are unprotected SSBs 205, while another UE 115 may report that third and fourth SSBs 205 (e.g., SSB #2-3) of SSB bursts 210 are protected SSBs 205, such that a first two and last SSBs 205 (e.g., SSB #0, 1, 4) are unprotected SSBs 205.

As described previously, scheduling of uplink communications via SBFD symbols (e.g., SSB symbols) associated with (e.g., used to transmit, used to receive) protected SSBs 205 (e.g., restricted SSBs 205) may be restricted. In other words, the UE 115-a may not expect to be scheduled (e.g., dynamically via downlink control information (DCI)) for uplink transmission when the UE 115-a measures protected SSBs 205. Thus, the UE 115-a may drop or cancel uplink transmissions (e.g., configured or scheduled by higher layers) when the UE 115-a measures protected SSBs 205. In other words, the UE 115-a may cancel uplink transmissions via SBFD symbols associated with protected SSBs 205.

Conversely, scheduling of uplink communications via SBFD symbols associated with unprotected SSBs 205 (e.g., unrestricted SSBs 205) may be unrestricted. In other words, the network entity 105-a may schedule (e.g., configure) uplink communications via the one or more uplink sub-bands of SBFD symbols associated with unprotected SSBs 205 (e.g., not measured by the UE 115-a). Thus, the UE 115-a may cancel measurement of unprotected SSBs 205 (e.g., via uplink DCI scheduling). In some examples, uplink communications may be scheduled by higher layers via one or more SBFD symbols, such that the UE 115-a may choose (e.g., determine) whether to measure SSBs 205 in the one or more SBFD symbols or perform uplink transmissions in the one or more SBFD symbols (e.g., if not measuring the SSBs 205). For example, CG-PUSCH may be scheduled via one or more SBFD symbols, such that the UE 115-a may determine whether to measure one or more SSBs associated with the one or more SBFD symbols or perform uplink communications in accordance with the CG-PUSCH.

In some cases, the UE 115-a may transmit the report 220 via L1 signaling (e.g., L1 reporting on PUCCH or PUSCH). For example, in some cases, the UE 115-a may transmit the report via UCI (e.g., a new UCI type). That is, the report 220 may be UCI indicating a bitmap (e.g., similar to unused transmission occasion (UTO)-UCI) with a length equal to a quantity of the multiple SSBs 205 indicating the one or more protected SSBs 205, the one or more unprotected SSBs 205, or both. For example, a bit value of 1 may indicate a protected SSB 205 (e.g., used SSB 205) and a bit value of 0 may indicate an unprotected SSB 205 (e.g., unused SSB 205). In some cases, the UE 115-a may be configured with persistent or semi-persistent resources (e.g., PUCCH resources) for transmitting the UCI including the bitmap. In some other cases, the UE 115-a may multiplex the bitmap (e.g., UCI including the bitmap) on a next PUSCH transmission. In such cases, the UCI may be associated with one or more rules for multiplexing the UCI (e.g., mapped after CSI-part2). Additionally, or alternatively, the UE 115-a may transmit the report 220 via a CSI report associated with SSB beam reporting. That is, the report 220 may be a CSI report (e.g., enhanced L1-beam reporting) that include an additional field for reporting the bitmap indicating the one or more protected SSBs 205, the one or more unprotected SSBs 205, or both. In such cases, the CSI report may include an SSB resource indicator (SSBRI) for a quantity (e.g., up to 4) of reported SSBs 205. In such cases, the reported SSBs 205 may be (e.g., assumed to be) protected SSBs 205. Thus, in some cases, the additional field (e.g., including the bitmap) may indicate the one or more protected SSBs 205 excluding the reported SSBs 205 (e.g., indicated in other fields of the CSI report) and, in some other cases, the bitmap may indicate the one or more unprotected SSBs 205.

Additionally, or alternatively, the UE 115-a may transmit the report 220 via L2 signaling (e.g., L2 reporting as an uplink medium access control (MAC)-control element (MAC-CE)). For example, the UE 115-a may transmit the report 220 via an uplink MAC-CE. That is, the UE 115-a may transmit an uplink MAC-CE including a bitmap, where the bitmap indicates the one or more protected SSBs 205, the one or more unprotected SSBs 205, or both. In such cases, a quantity of octets in the uplink MAC-CE may be a quantity of SSBs 205 (e.g., unprotected SSB 205 or protected SSBs 205) divided by 8. Additionally, or alternatively, the UE 115-a may transmit the report 220 via L3 signaling. For example, the UE 115-a may transmit the report 220 via UE assistance information (UAI).

In some examples, the UE 115-a may transmit the report 220 based on one or more trigger events, where the one or more trigger events are based on a reporting mechanism (e.g., L1, L2, or L3 reporting). For example, for L1 reporting, the one or more trigger events may be based on whether reporting is via PUSCH or PUCCH. For example, the UE 115-a may transmit the report 220 based on an aperiodic trigger from the network entity 105-a for reporting on PUSCH. In another example, UCI including the report 220 may be multiplexed on a first scheduled PUSCH in a frame, where the UCI is multiplexed every quantity, X, of frames (e.g., periodically). In another example, the UE 115-a may transmit the report 220 persistently or semi-persistently on PUCCH.

For L2 reporting, the one or more trigger events may be based on expiration of a timer, a change in a set of protected SSBs 205, or both. For example, the UE 115-a may initiate a timer based on transmission of the report 220 and may transmit a second report 220 based on expiration of the timer (e.g., periodically). Additionally, or alternatively, the UE 115-a may transmit the report 220 based on a change in a set of protected SSBs 205. For example, the UE 115-a may transmit a first report 220 indicating the set of protected SSBs 205 as a first two SSBs 205 of each unprotected SSB burst 210 may update the set of protected SSBs 205 to be a first three SSBs 205 of each unprotected SSB burst 210, such that the UE 115-a may transmit a second report 220 based on the update. In some cases (e.g., for L2 reporting and UAI for L3 reporting), the UE 115-a may transmit the report 220 autonomously based on configuration of the UE 115-a (e.g., RRC configuration of a reporting procedure), based on (e.g., triggered by) a query from the network entity 105-a, or both.

In some examples, the UE 115-a may initiate a second timer based on transmission of the report 220 and may fall back to a default state based on expiration of the timer, where the default state defines one or more protected SSBs 205, one or more protected SSB bursts 210, one or more unprotected SSBs 205, one or more unprotected SSB bursts 210, or any combination thereof. For example, the default state may be associated with all SSB bursts 210 or all SSBs 205 being protected SSB bursts 210 or protected SSBs 205, respectively.

In some cases, as described previously, the UE 115-a may transmit a second report 220 updating protection information (e.g., the one or more protected SSBs 205, the one or more protected SSB bursts 210, the one or more unprotected SSBs 205, the one or more unprotected SSB bursts 210, or any combination thereof). However, the UE 115-a may apply the updated protection information based on an offset 225 relative to transmission of the second report 220. In such cases, the offset 225 may be a time (e.g., ms), a quantity of symbols, a quantity of slots, or the like thereof. For example, the UE 115-a may transmit a first report indicating that a first two SSBs 205 (e.g., SSB #0-1) of subsequent SSB bursts 210 are protected SSBs 205, such that a last three SSBs 205 (e.g., SSB #2, 3, 4) of the subsequent SSB bursts 210 are unprotected SSBs 205. Additionally, at a time T₁, the UE 115-a may transmit a second report indicating a first three SSBs 205 (e.g., SSB #0-2) of subsequent SSB bursts 210 are protected SSBs 205, such that a last two SSBs 205 (e.g., SSB #3, 4) of the subsequent SSB bursts 210 are unprotected SSBs 205. However, the UE 115-a may refrain from updating the protected SSBs 205 from the first two SSBs to the first three SSBs 205 until a time T₂ (e.g., the offset 225 from the time T₁). That is, even though the UE 115-a may transmit the second report 220 prior to the SSB burst 210-c, the SSB 205-e and the SSB 205-f may be protected SSBs 205 (e.g., the only protected SSBS 205) in the SSB burst 210-c based on the SSB burst 210-c being prior to the time T₂. Thus, an SSB 205-g, an SSB 205-h, and an SSB 205-j of the SSB burst 210-d may be protected SSBs 205 based on the SSB burst 210-d being after the time T₂.

In some examples, the UE 115-a may transmit a capability message indicating a capability of the UE 115-a to support scheduling of uplink communications in SBFD symbols associated with SSBs 205. For example, the UE 115-a may transmit the capability message indicating a capability of the UE 115-a to support scheduling of uplink communications in SBFD symbols associated with SSBs 205 based on configuration by the network entity 105-a without UE reporting of protected SSBs 205.

Additionally, or alternatively, the UE 115-a may transmit the capability message indicating a capability of the UE 115-a to support scheduling of uplink communications in SBFD symbols associated with unprotected SSBs 205, unprotected SSB bursts, or both, based on UE reporting (e.g., based on transmission of reports 220). In some cases, the UE 115-a may not transmit a capability message indicating a capability of the UE 115-a to support scheduling of uplink communications in SBFD symbols associated with SSBs 205. In such cases, the UE 115-a may not be capable of being scheduled with uplink communications in SBFD symbols associated with SSBs 205 (e.g., in SSB symbols located in SBFD symbols).

In some cases, the multiple SSBs 205 configured for the UE 115-a may include SSBs 205 to be transmitted by the network entity 105-a (e.g., according to ssb-PositionsInBurst in SI or according to ssb-ToMeasure for SSBs 205 in an SMTC) or may include the SSBs 205 to be transmitted by the network entity 105-a and candidate SSBs 205 not transmitted by the network entity 105-a (e.g., not included in ssb-PositionsInBurst or in ssb-ToMeasure). Thus, in some cases, the one or more protected SSBs 205, the one or more protected SSB bursts 210, the one or more unprotected SSBs 205, the one or more unprotected SSB bursts 210, or any combination thereof, reported by the UE 115-a may be from a combination of the SSBs 205 to be transmitted by the network entity 105-a and the candidate SSBs 205. In some other cases, the one or more protected SSBs 205, the one or more protected SSB bursts 210, the one or more unprotected SSBs 205, the one or more unprotected SSB bursts 210, or any combination thereof, reported by the UE 115-a may be from the SSBs 205 to be transmitted by the network entity 105-a (e.g., according to ssb-PositionsInBurst in SI or according to ssb-ToMeasure for SSBs 205 in an SMTC). In such cases, the candidate SSBs 205 not transmitted by the network entity 105-a (e.g., muted SSBs 205) may not be subject to restrictions associated with scheduling of uplink communications.

In some cases, no restrictions may exist for SBFD symbols associated with secondary cells (e.g., SCells, intra-band SCells), regardless of SSB 205 presence. In such cases, the UE 115-a may monitor a primary cell for SSBs 205. In other words, the network entity 105-a may be a primary cell.

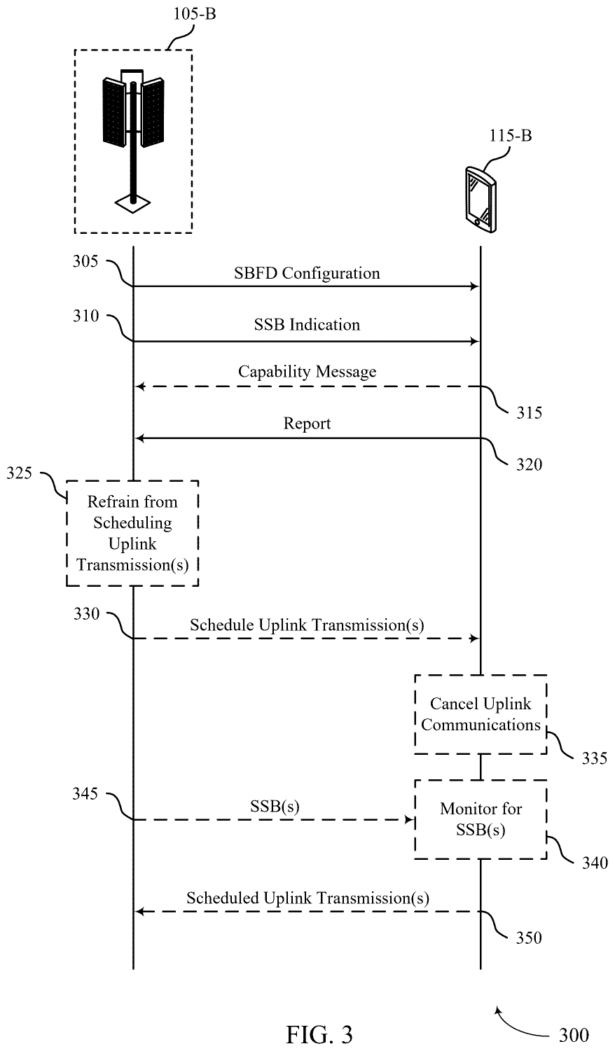

FIG. 3 shows an example of a process flow 300 that supports techniques for reporting of measured SSB for sub-band full-duplex operation in accordance with one or more aspects of the present disclosure. In some cases, the process flow 300 may implement or be implemented by aspects of the wireless communications system 100, the wireless communications system 200, or both. For example, the process flow 300 may include one or more UEs 115 (e.g., a UE 115-b) and one or more network entities 105 (e.g., a network entity 105-b), which may be examples of the corresponding devices as described herein. In the following description of the process flow 300, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 300, and other operations may be added to the process flow 300.

At 305, the UE 115-b may receive, form the network entity 105-b, a first control message indicating an SBFD pattern for SBFD symbols (e.g., an SBFD configuration), where the SBDS pattern may indicate one or more uplink sub-bands for the SBFD symbols and one or more downlink sub-bands for the SBFD symbol. In some cases, the UE 115-b may be a half-duplex UE 115. In other words, the UE 115-b may be an SBFD-aware UE 115 and the network entity 105-b may be an SBFD network entity 105. Additionally, or alternatively, the network entity 105-b may be a primary cell (E.g., where uplink transmissions are unrestricted via one or more SBFD symbols associated with one or more secondary cells).

At 310, the UE 115-b may receive a second control message scheduling multiple SSBs via multiple SBFD symbols, where the multiple SSBs are associated with multiple SSB bursts. In some cases, the second control message may indicate a subset of the multiple SSBs that are configured for measurement by the UE 115-b (e.g., to be transmitted by the network entity 105-b).

In some cases, at 315, the UE 115-b may transmit a capability message that indicates a capability of the UE 115-b to be scheduled with uplink communications via the multiple SBFD symbols associated with the multiple SSBs. In some cases, the capability message may indicate a capability of the UE 115-b to transmit uplink communications via the multiple SBFD symbols in accordance with configuration information received from the network entity 105-b. Additionally, or alternatively, the capability message may indicate a capability of the UE 115-b to report one or more SSB bursts that each include one or more SSBs to be measured by the UE 115 (e.g., and/or the one or more SSBs).

At 320, the UE 115-b may transmit a report indicating the one or more SSB bursts (e.g., unprotected SSB bursts, protected SSB bursts), from the multiple SSB bursts, that each include the one or more SSBs to be measured by the UE 115 (e.g., protected SSB bursts), where uplink communications (e.g., scheduling of uplink communications, scheduling of uplink transmissions) may be restricted during one or more first SBFD symbols (e.g., of the multiple SBFD symbols) associated with each of the one or more SSB bursts based on the one or more first SBFD symbols including the one or more SSBs to be measured by the UE 115-b. In some cases, the one or more SSBs may be from the subset of the multiple SSBs that are configured for measurement by the UE 115-b (e.g., to be transmitted by the network entity 105-b).

In some cases, the report may include a bitmap indicating the one or more SSB bursts from the multiple SSB bursts. Additionally, or alternatively, the report may include an indication of a periodicity and a time offset associated with the one or more SSB bursts. Additionally, or alternatively, the report may include an indication defined by a window and a duration, where the window includes the one or more SSB bursts. In such cases, the report may further indicate a periodicity associated with the window.

Additionally, or alternatively, the report may indicate the one or more SSBs to be measured by the UE 115-b (e.g., protected SSBs, protected SSB indices) during each of the one or more SSB bursts, may indicate one or more second SSBs not to be measured by the UE 115-b (e.g., unprotected SSBs, unprotected SSB indices) during each of the one or more SSB bursts, or both. In either case, restricting uplink communications during the one or more first SBFD symbols associated with the one or more SSBs to be measured by the UE 115-b may be based on indicating the one or more SSBs, the one or more second SSBs, or both.

In some cases, the report may be transmitted via UCI, a CSI report, a MAC-CE, UAI, or any combination thereof. Additionally, or alternatively, the report may be transmitted aperiodically, periodically, persistently, semi-persistently, by event triggering, or any combination thereof. In some cases, the report may be transmitted based on a change in the one or more SSBs to be measured by the UE 115-b. In some cases, the UE 115-b may initiate a timer based on transmission of the report, where uplink communications are restricted during all SBFD symbols based on expiration of the timer.

In some cases, at 325, the network entity 105-b may refrain from scheduling uplink communications during the one or more first SBFD symbols based on receiving the report. In other words, the network entity 105-b may refrain from scheduling uplink communications during the one or more first SBFD symbols based on uplink communications being restricted during the one or more first SBFD symbols.

In some cases, at 330, the UE 115-b may receive a third control message scheduling uplink communications via one or more second SBFD symbols associated with the one or more SSB bursts, where the one or more second SBFD symbols are associated with the one or more second SSBs not to be measured by the UE 115-b (e.g., unprotected SSBs). That is, the uplink communications may be scheduled via the one or more second SBFD symbols based on the one nor more second SBFD symbols including the one or more second SSBs. Thus, the UE 115-b may cancel measurement on the one or more second SSBs based on receiving the third control message.

In some cases, at 335, the UE 115-b may cancel uplink transmissions via the one or more first SBFD symbols based on transmitting the report indicating the one or more SSBs to be monitored by the UE 115-b (e.g., based on intending to monitor for the one or more SSBs during the one or more first SBFD symbols). In other words, the UE 115-b may restrict uplink communications during the one or more first SBFD symbols based on transmitting the report. In some cases, the restriction may be based on the report being transmitted a threshold duration prior to the one or more first SBFD symbols.

In some examples, the UE 115-b may not retransmit the canceled uplink transmissions. Additionally, the network entity 105-b may be aware of the canceled uplink transmissions (e.g., implicitly) based on transmission of the report.

In some cases, at 340, the UE 115-b may monitor for the one or more SSBs (e.g., to be measured by the UE 115-b) via the one or more first SBFD symbols based on transmitting the report. Thus, at 345, the network entity 105-b may transmit the one or more SSBs via the one or more SBFD symbols.

In some examples, at 350, the UE 115-b may transmit the uplink communications (e.g., scheduled by the third control message) via the one or more second SBFD symbols associated with the one or more SSB bursts.

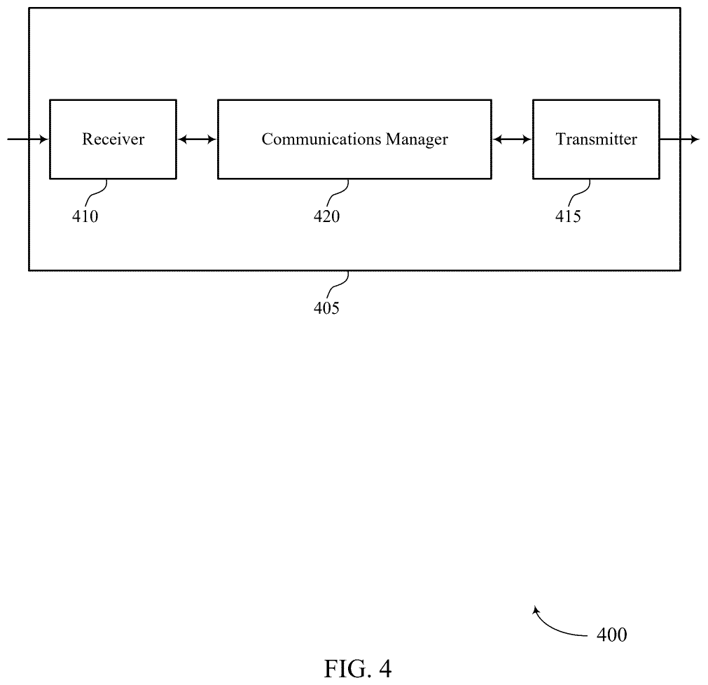

FIG. 4 shows a block diagram 400 of a device 405 that supports techniques for reporting of measured SSB for sub-band full-duplex operation in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for reporting of measured SSB for sub-band full-duplex operation). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for reporting of measured SSB for sub-band full-duplex operation). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of techniques for reporting of measured SSB for sub-band full-duplex operation as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving a first control message indicating a SBFD pattern for SBFD symbols, where the SBFD pattern indicates one or more uplink sub-bands for the SBFD symbols and one or more downlink sub-bands for the SBFD symbols. The communications manager 420 is capable of, configured to, or operable to support a means for receiving a second control message scheduling a set of multiple SSBs via a set of multiple SBFD symbols, where the set of multiple SSBs are associated with a set of multiple SSB bursts. The communications manager 420 is capable of, configured to, or operable to support a means for transmitting a report indicating one or more SSB bursts, from the set of multiple SSB bursts, that each include one or more SSBs to be measured by the device 405, where uplink communications are restricted during one or more first SBFD symbols associated with each of the one or more SSB bursts based on the one or more first SBFD symbols including the one or more SSBs to be measured by the device 405.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reporting of protected SSBs for restriction of uplink communications during SBFD operations, which may result in reduced processing, reduced power consumption, and more efficient utilization of communication resources, among other advantages.

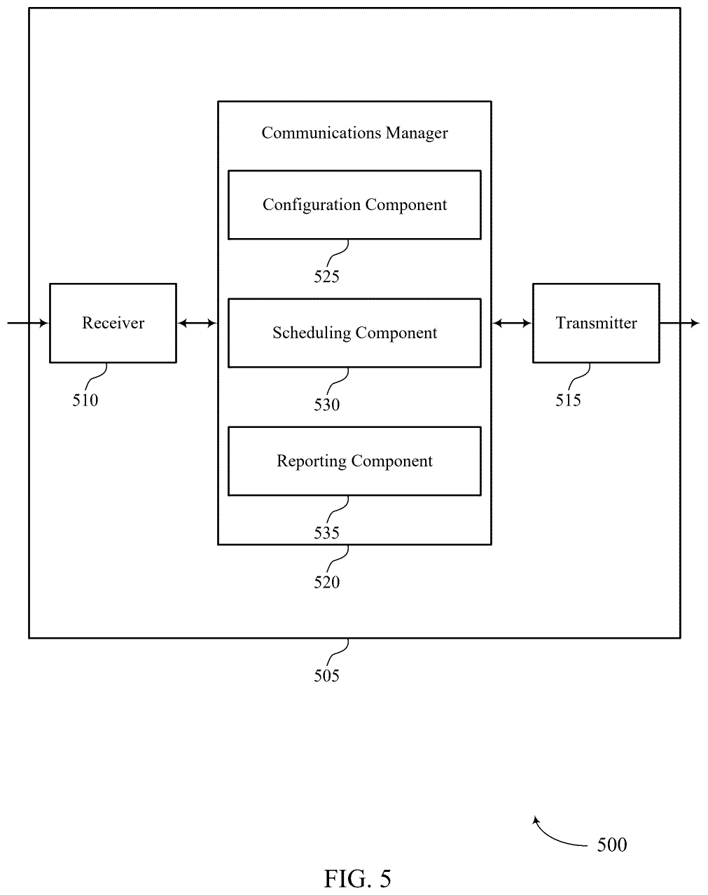

FIG. 5 shows a block diagram 500 of a device 505 that supports techniques for reporting of measured SSB for SBFD operation in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for reporting of measured SSB for SBFD operation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for reporting of measured SSB for SBFD operation). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for reporting of measured SSB for SBFD operation as described herein. For example, the communications manager 520 may include a configuration component 525, a scheduling component 530, a reporting component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The configuration component 525 is capable of, configured to, or operable to support a means for receiving a first control message indicating an SBFD pattern for SBFD symbols, where the SBFD pattern indicates one or more uplink sub-bands for the SBFD symbols and one or more downlink sub-bands for the SBFD symbols. The scheduling component 530 is capable of, configured to, or operable to support a means for receiving a second control message scheduling a set of multiple SSBs via a set of multiple SBFD symbols, where the set of multiple SSBs are associated with a set of multiple SSB bursts. The reporting component 535 is capable of, configured to, or operable to support a means for transmitting a report indicating one or more SSB bursts, from the set of multiple SSB bursts, that each include one or more SSBs to be measured by the device 505, where uplink communications are restricted during one or more first SBFD symbols associated with each of the one or more SSB bursts based on the one or more first SBFD symbols including the one or more SSBs to be measured by the device 505.

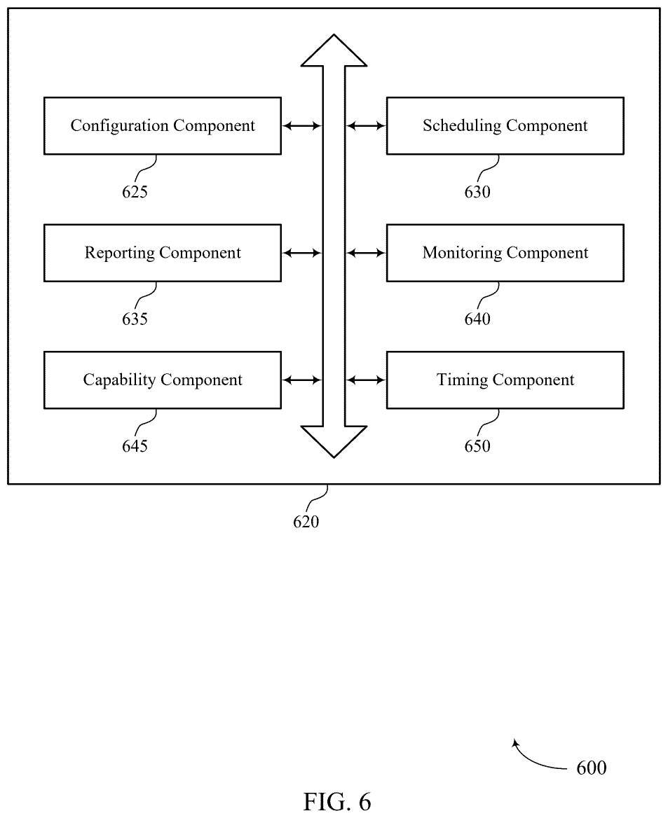

FIG. 6 shows a block diagram 600 of a communications manager 620 that supports techniques for reporting of measured SSB for SBFD operation in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for reporting of measured SSB for SBFD operation as described herein. For example, the communications manager 620 may include a configuration component 625, a scheduling component 630, a reporting component 635, a monitoring component 640, a capability component 645, a timing component 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The configuration component 625 is capable of, configured to, or operable to support a means for receiving a first control message indicating an SBFD pattern for SBFD symbols, where the SBFD pattern indicates one or more uplink sub-bands for the SBFD symbols and one or more downlink sub-bands for the SBFD symbols. The scheduling component 630 is capable of, configured to, or operable to support a means for receiving a second control message scheduling a set of multiple SSBs via a set of multiple SBFD symbols, where the set of multiple SSBs are associated with a set of multiple SSB bursts. The reporting component 635 is capable of, configured to, or operable to support a means for transmitting a report indicating one or more SSB bursts, from the set of multiple SSB bursts, that each include one or more SSBs to be measured by the UE, where uplink communications are restricted during one or more first SBFD symbols associated with each of the one or more SSB bursts based on the one or more first SBFD symbols including the one or more SSBs to be measured by the UE.

In some examples, the report includes a bitmap indicating the one or more SSB bursts from the set of multiple SSB bursts.

In some examples, the report includes an indication of a periodicity and a time offset associated with the one or more SSB bursts.

In some examples, the report includes an indication of a window defined by a slot offset and a duration. In some examples, the window includes the one or more SSB bursts.

In some examples, the report further indicates a periodicity associated with the window.

In some examples, to support transmitting the report, the reporting component 635 is capable of, configured to, or operable to support a means for transmitting an indication of the one or more SSBs to be measured by the UE during each of the one or more SSB bursts, where restricting uplink communication during the one or more first SBFD symbols is based on indicating the one or more SSBs to be measured by the UE.

In some examples, the report is transmitted via UCI, a CSI report, a MAC-CE, UE assistance UAI, or any combination thereof.

In some examples, the report is transmitted aperiodically, periodically, persistently, semi-persistently, by event triggering, or any combination thereof.

In some examples, the report is transmitted based on a change in the one or more SSBs to be measured by the UE.

In some examples, the timing component 650 is capable of, configured to, or operable to support a means for initiating a timer based on transmission of the report, where uplink communications are restricted during all SBFD symbols based on expiration of the timer.

In some examples, to support transmitting the report, the reporting component 635 is capable of, configured to, or operable to support a means for transmitting an indication of one or more second SSBs not to be measured by the UE during each of the one or more SSB bursts, where restricting uplink communication during the one or more first SBFD symbols including the one or more SSBs to be measured by the UE is based on indicating the one or more second SSBs not to be measured by the UE.

In some examples, the report is transmitted via UCI, a CSI report, a MAC-CE, UAI, or any combination thereof.

In some examples, the report is transmitted aperiodically, periodically, persistently, semi-persistently, by event triggering, or any combination thereof.

In some examples, the report is transmitted based on a change in the one or more SSBs to be measured by the UE.

In some examples, the timing component 650 is capable of, configured to, or operable to support a means for initiating a timer based on transmission of the report, where uplink communications are restricted during all SBFD symbols based on expiration of the timer.

In some examples, the monitoring component 640 is capable of, configured to, or operable to support a means for monitoring for the one or more SSBs via the one or more first SBFD symbols based on transmitting the report.

In some examples, the scheduling component 630 is capable of, configured to, or operable to support a means for canceling uplink transmissions via the one or more first SBFD symbols based on monitoring for the one or more SSBs via the one or more first SBFD symbols.

In some examples, the scheduling component 630 is capable of, configured to, or operable to support a means for receiving a third control message scheduling uplink communications via one or more second SBFD symbols associated with the one or more SSB bursts based on the one or more second SBFD symbols including one or more second SSBs not to be measured by the UE.

In some examples, the monitoring component 640 is capable of, configured to, or operable to support a means for canceling measurement on the one or more second SSBs based on receiving the third control message.

In some examples, the UE restricts uplink communications during the one or more first SBFD symbols based on the report being transmitted a threshold duration prior to the one or more first SBFD symbols.

In some examples, the capability component 645 is capable of, configured to, or operable to support a means for transmitting a capability message that indicates a capability of the UE to be scheduled with uplink communications via a set of multiple SBFD symbols associated with the set of multiple SSBs.

In some examples, to support transmitting the capability message, the capability component 645 is capable of, configured to, or operable to support a means for transmitting the capability message indicating a capability of the UE to report the one or more SSBs to be measured by the UE.

In some examples, to support transmitting the capability message, the capability component 645 is capable of, configured to, or operable to support a means for transmitting the capability message indicating a capability of the UE to transmit uplink communications via the set of multiple SBFD symbols in accordance with configuration information received from a network entity.

In some examples, the one or more SSBs are from a subset of the set of multiple SSBs. In some examples, the subset of the set of multiple SSBs are configured for measurements by the UE.

In some examples, the one or more SSBs are received from a primary cell. In some examples, uplink transmissions are unrestricted via one or more SBFD symbols associated with one or more secondary cells.

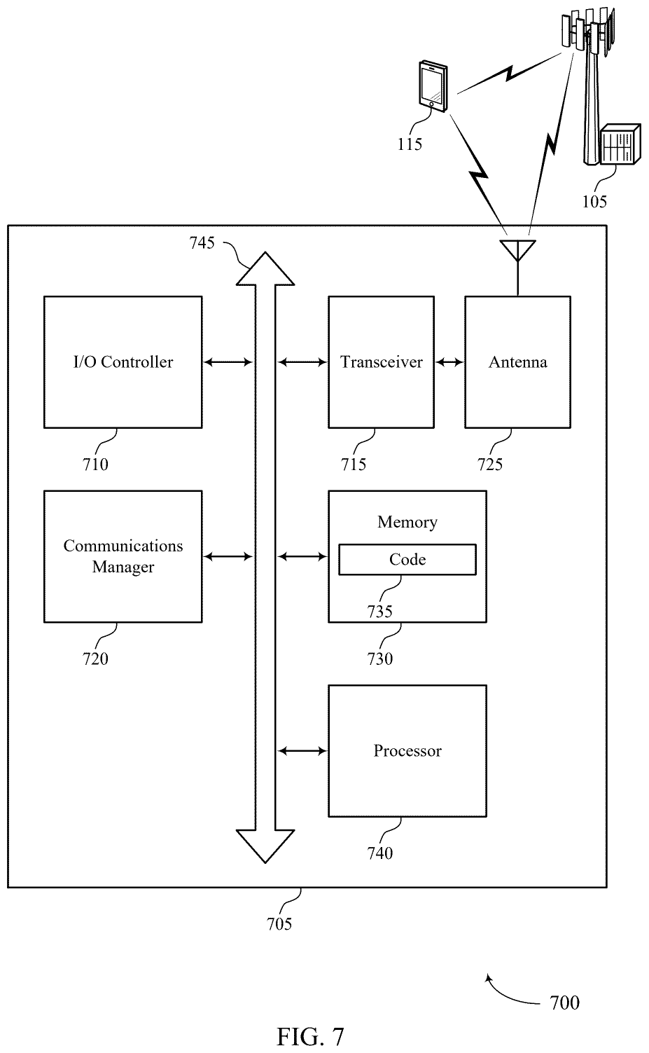

FIG. 7 shows a diagram of a system 700 including a device 705 that supports techniques for reporting of measured SSB for SBFD operation in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for reporting of measured SSB for SBFD operation). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving a first control message indicating an SBFD pattern for SBFD symbols, where the SBFD pattern indicates one or more uplink sub-bands for the SBFD symbols and one or more downlink sub-bands for the SBFD symbols. The communications manager 720 is capable of, configured to, or operable to support a means for receiving a second control message scheduling a set of multiple SSBs via a set of multiple SBFD symbols, where the set of multiple SSBs are associated with a set of multiple SSB bursts. The communications manager 720 is capable of, configured to, or operable to support a means for transmitting a report indicating one or more SSB bursts, from the set of multiple SSB bursts, that each include one or more SSBs to be measured by the device 705, where uplink communications are restricted during one or more first SBFD symbols associated with each of the one or more SSB bursts based on the one or more first SBFD symbols including the one or more SSBs to be measured by the device 705.

By including or configuring the communications manager 720 in accordance with examples as described herein, the device 705 may support techniques for reporting of protected SSBs for restriction of uplink communications during SBFD operations, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described herein with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for reporting of measured SSB for SBFD operation as described herein, or the at least one processor 740 and the at least one memory 730 may be otherwise configured to, individually or collectively, perform or support such operations.

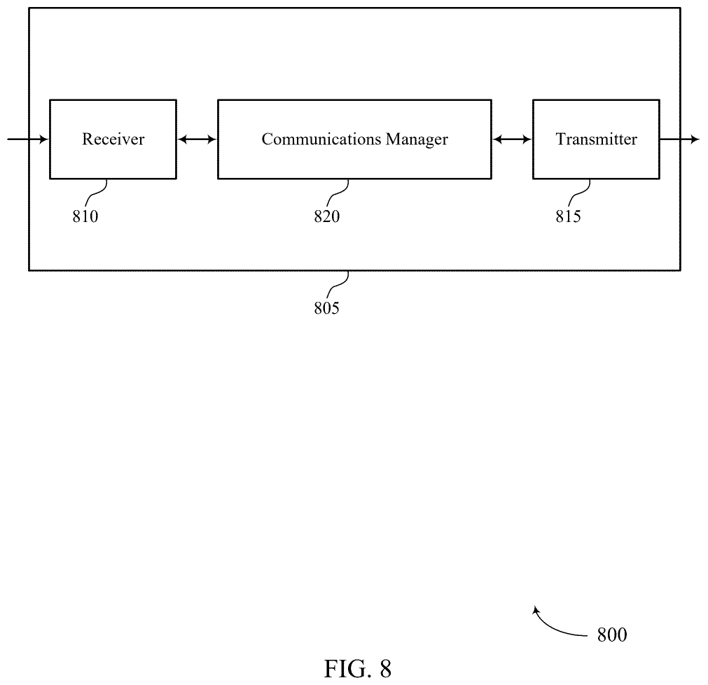

FIG. 8 shows a block diagram 800 of a device 805 that supports techniques for reporting of measured SSB for SBFD operation in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of techniques for reporting of measured SSB for SBFD operation as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting a first control message indicating an SBFD pattern for SBFD symbols, where the SBFD pattern indicates one or more uplink sub-bands for the SBFD symbols and one or more downlink sub-bands for the SBFD symbols. The communications manager 820 is capable of, configured to, or operable to support a means for transmitting a second control message scheduling a set of multiple SSBs via a set of multiple SBFD symbols, where the set of multiple SSBs are associated with a set of multiple SSB bursts. The communications manager 820 is capable of, configured to, or operable to support a means for receiving a report indicating one or more SSB bursts, from the set of multiple SSB bursts, that each include one or more SSBs to be measured by a UE, where uplink communications are restricted during one or more first SBFD symbols associated with each of the one or more SSB bursts based on the one or more first SBFD symbols including the one or more SSBs to be measured by the UE.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reporting of protected SSBs for restriction of uplink communications during SBFD operations, which may result in reduced processing, reduced power consumption, and more efficient utilization of communication resources, among other advantages.

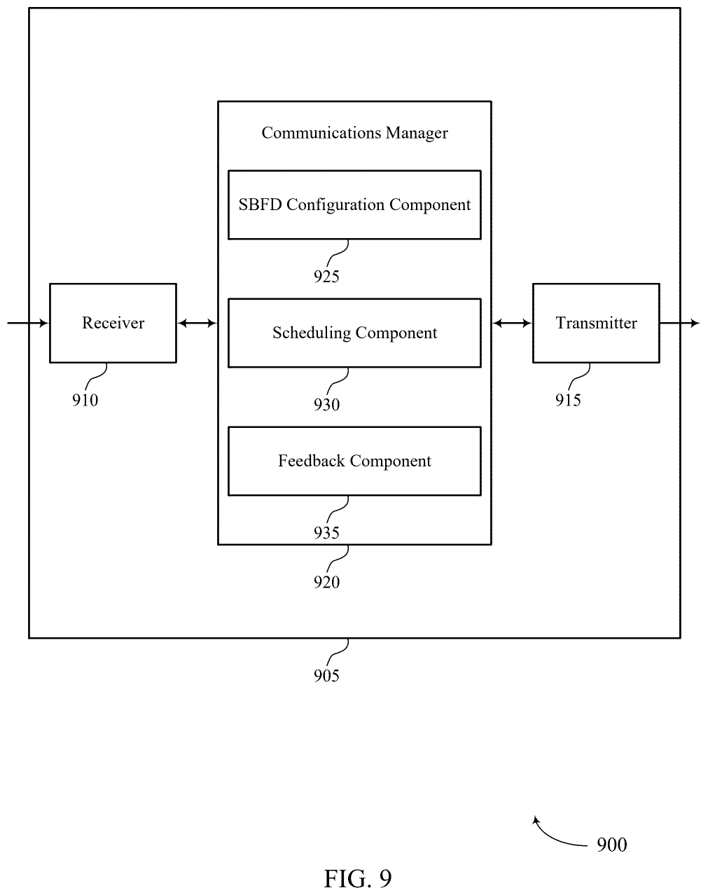

FIG. 9 shows a block diagram 900 of a device 905 that supports techniques for reporting of measured SSB for SBFD operation in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for reporting of measured SSB for SBFD operation as described herein. For example, the communications manager 920 may include an SBFD configuration component 925, a scheduling component 930, a feedback component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The SBFD configuration component 925 is capable of, configured to, or operable to support a means for transmitting a first control message indicating an SBFD pattern for SBFD symbols, where the SBFD pattern indicates one or more uplink sub-bands for the SBFD symbols and one or more downlink sub-bands for the SBFD symbols. The scheduling component 930 is capable of, configured to, or operable to support a means for transmitting a second control message scheduling a set of multiple SSBs via a set of multiple SBFD symbols, where the set of multiple SSBs are associated with a set of multiple SSB bursts. The feedback component 935 is capable of, configured to, or operable to support a means for receiving a report indicating one or more SSB bursts, from the set of multiple SSB bursts, that each include one or more SSBs to be measured by a UE, where uplink communications are restricted during one or more first SBFD symbols associated with each of the one or more SSB bursts based on the one or more first SBFD symbols including the one or more SSBs to be measured by the UE.

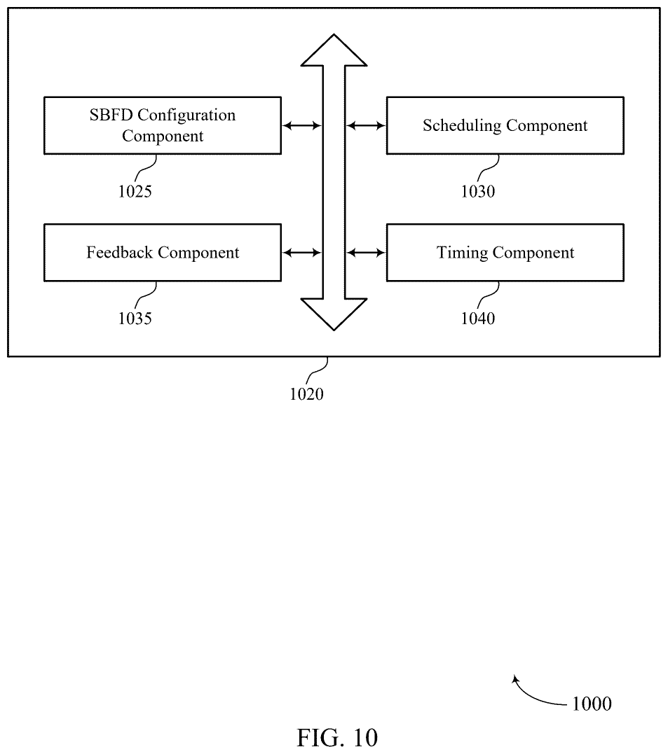

FIG. 10 shows a block diagram 1000 of a communications manager 1020 that supports techniques for reporting of measured SSB for SBFD operation in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for reporting of measured SSB for SBFD operation as described herein. For example, the communications manager 1020 may include an SBFD configuration component 1025, a scheduling component 1030, a feedback component 1035, a timing component 1040, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The SBFD configuration component 1025 is capable of, configured to, or operable to support a means for transmitting a first control message indicating an SBFD pattern for SBFD symbols, where the SBFD pattern indicates one or more uplink sub-bands for the SBFD symbols and one or more downlink sub-bands for the SBFD symbols. The scheduling component 1030 is capable of, configured to, or operable to support a means for transmitting a second control message scheduling a set of multiple SSBs via a set of multiple SBFD symbols, where the set of multiple SSBs are associated with a set of multiple SSB bursts. The feedback component 1035 is capable of, configured to, or operable to support a means for receiving a report indicating one or more SSB bursts, from the set of multiple SSB bursts, that each include one or more SSBs to be measured by a UE, where uplink communications are restricted during one or more first SBFD symbols associated with each of the one or more SSB bursts based on the one or more first SBFD symbols including the one or more SSBs to be measured by the UE.

In some examples, the report includes a bitmap indicating the one or more SSB bursts from the set of multiple SSB bursts.

In some examples, the report includes an indication of a periodicity and a time offset associated with the one or more SSB bursts.

In some examples, the report includes an indication of a window defined by a slot offset and a duration. In some examples, the window includes the one or more SSB bursts.

In some examples, the report further indicates a periodicity associated with the window.

In some examples, to support receiving the report, the feedback component 1035 is capable of, configured to, or operable to support a means for receiving an indication of the one or more SSBs to be measured by the UE during each of the one or more SSB burst, where restricting uplink communication during the one or more first SBFD symbols is based on indicating the one or more SSBs to be measured by the UE.

In some examples, the report is received via UCI, a CSI report, a MAC-CE, UE assistance UAI, or any combination thereof.

In some examples, the report is received aperiodically, periodically, persistently, semi-persistently, by event triggering, or any combination thereof.

In some examples, the report is received based on a change in the one or more SSBs to be measured by the UE.

In some examples, the timing component 1040 is capable of, configured to, or operable to support a means for initiating a timer based on reception of the report, where uplink communications are restricted during all SBFD symbols based on expiration of the timer.

In some examples, to support receiving the report, the feedback component 1035 is capable of, configured to, or operable to support a means for receiving an indication of one or more second SSBs not to be measured by the UE during each of the one or more SSB bursts, where restricting uplink communication during the one or more first SBFD symbols including the one or more SSBs to be measured by the UE is based on indicating the one or more second SSBs not to be measured by the UE.

In some examples, the report is received via UCI, a CSI report, a MAC-CE, UAI, or any combination thereof.

In some examples, the report is received aperiodically, periodically, persistently, semi-persistently, by event triggering, or any combination thereof.

In some examples, the report is received based on a change in the one or more SSBs to be measured by the UE.

In some examples, the timing component 1040 is capable of, configured to, or operable to support a means for initiating a timer based on reception of the report, where uplink communications are restricted during all SBFD symbols based on expiration of the timer.

In some examples, the scheduling component 1030 is capable of, configured to, or operable to support a means for refraining from scheduling uplink communications during the one or more first SBFD symbols based on uplink communications being restricted during the one or more first SBFD symbols.

In some examples, the scheduling component 1030 is capable of, configured to, or operable to support a means for transmitting a third control message scheduling uplink communications via one or more second SBFD symbols associated with the one or more SSB bursts based on the one or more second SBFD symbols including one or more second SSBs not to be measured by the UE.

In some examples, the network entity restricts uplink communications during the one or more first SBFD symbols based on the report being received a threshold duration prior to the one or more first SBFD symbols.

In some examples, the feedback component 1035 is capable of, configured to, or operable to support a means for receiving a capability message that indicates a capability of the UE to be scheduled with uplink communications via a set of multiple SBFD symbols associated with the set of multiple SSBs.

In some examples, to support receiving the capability message, the feedback component 1035 is capable of, configured to, or operable to support a means for receiving the capability message indicating a capability of the UE to report the one or more SSBs to be measured by the UE.

In some examples, to support receiving the capability message, the feedback component 1035 is capable of, configured to, or operable to support a means for receiving the capability message indicating a capability of the UE to transmit uplink communications via the set of multiple SBFD symbols in accordance with configuration information transmitted by the network entity.

In some examples, the one or more SSBs are from a subset of the set of multiple SSBs. In some examples, the subset of the set of multiple SSBs are configured for measurements by the UE.

In some examples, the network entity is a primary cell. In some examples, uplink transmissions are unrestricted via one or more SBFD symbols associated with one or more secondary cells.

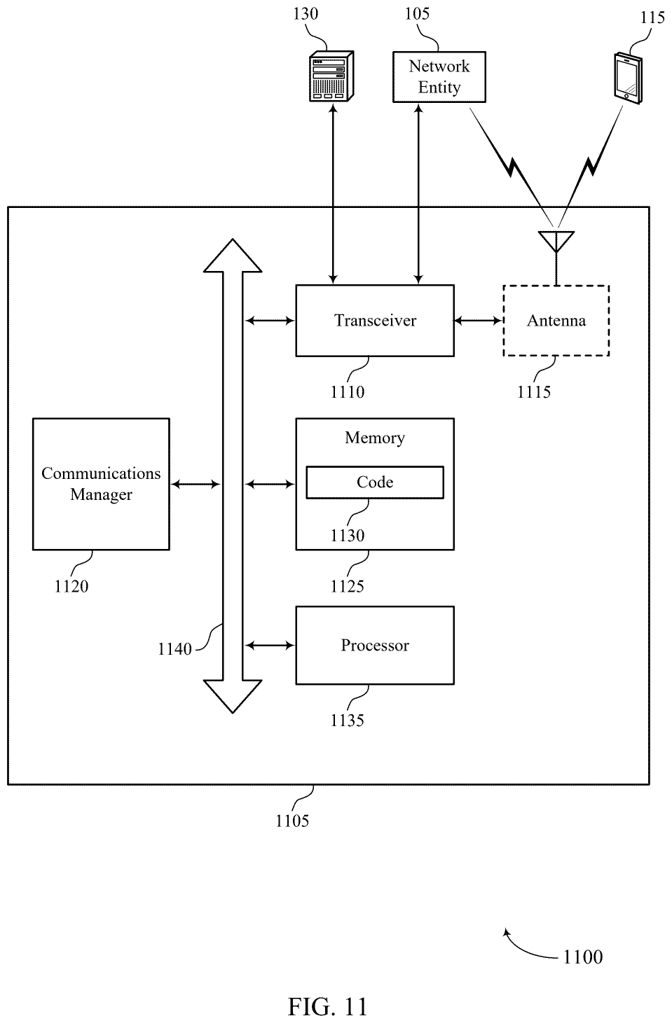

FIG. 11 shows a diagram of a system 1100 including a device 1105 that supports techniques for reporting of measured SSB for SBFD operation in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for reporting of measured SSB for SBFD operation). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for transmitting a first control message indicating an SBFD pattern for SBFD symbols, where the SBFD pattern indicates one or more uplink sub-bands for the SBFD symbols and one or more downlink sub-bands for the SBFD symbols. The communications manager 1120 is capable of, configured to, or operable to support a means for transmitting a second control message scheduling a set of multiple SSBs via a set of multiple SBFD symbols, where the set of multiple SSBs are associated with a set of multiple SSB bursts. The communications manager 1120 is capable of, configured to, or operable to support a means for receiving a report indicating one or more SSB bursts, from the set of multiple SSB bursts, that each include one or more SSBs to be measured by a UE, where uplink communications are restricted during one or more first SBFD symbols associated with each of the one or more SSB bursts based on the one or more first SBFD symbols including the one or more SSBs to be measured by the UE.

By including or configuring the communications manager 1120 in accordance with examples as described herein, the device 1105 may support techniques for reporting of protected SSBs for restriction of uplink communications during SBFD operations, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described herein with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for reporting of measured SSB for SBFD operation as described herein, or the at least one processor 1135 and the at least one memory 1125 may be otherwise configured to, individually or collectively, perform or support such operations.

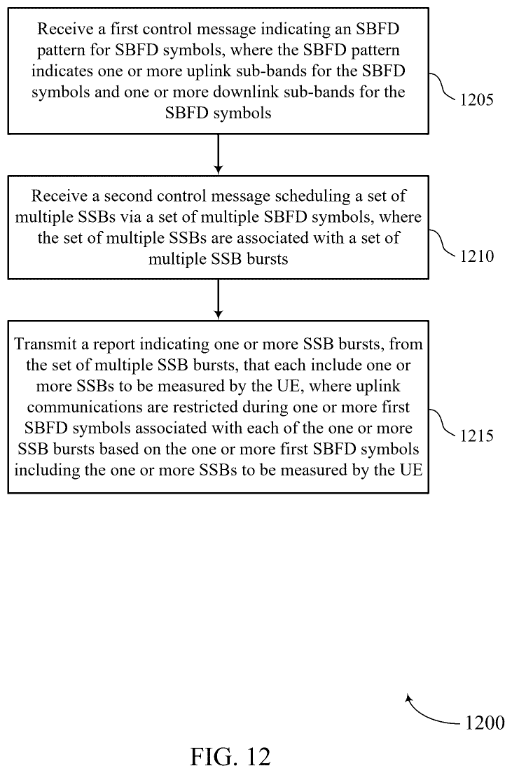

FIG. 12 shows a flowchart illustrating a method 1200 that supports techniques for reporting of measured SSB for SBFD operation in accordance with one or more aspects of the present disclosure. The operations of the method 1200 may be implemented by a UE or its components as described herein. For example, the operations of the method 1200 may be performed by a UE 115 as described herein with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a first control message indicating an SBFD pattern for SBFD symbols, where the SBFD pattern indicates one or more uplink sub-bands for the SBFD symbols and one or more downlink sub-bands for the SBFD symbols. The operations of 1205 may be performed in accordance with examples as disclosed herein. In some examples, aspects of the operations of 1205 may be performed by a configuration component 625 as described herein with reference to FIG. 6.

At 1210, the method may include receiving a second control message scheduling a set of multiple SSBs via a set of multiple SBFD symbols, where the set of multiple SSBs are associated with a set of multiple SSB bursts. The operations of 1210 may be performed in accordance with examples as disclosed herein. In some examples, aspects of the operations of 1210 may be performed by a scheduling component 630 as described herein with reference to FIG. 6.

At 1215, the method may include transmitting a report indicating one or more SSB bursts, from the set of multiple SSB bursts, that each include one or more SSBs to be measured by the UE, where uplink communications are restricted during one or more first SBFD symbols associated with each of the one or more SSB bursts based on the one or more first SBFD symbols including the one or more SSBs to be measured by the UE. The operations of 1215 may be performed in accordance with examples as disclosed herein. In some examples, aspects of the operations of 1215 may be performed by a reporting component 635 as described herein with reference to FIG. 6.

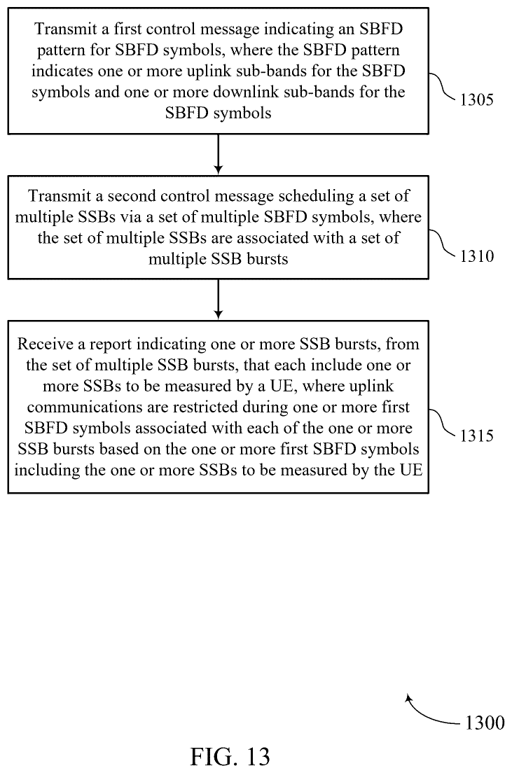

FIG. 13 shows a flowchart illustrating a method 1300 that supports techniques for reporting of measured SSB for SBFD operation in accordance with one or more aspects of the present disclosure. The operations of the method 1300 may be implemented by a network entity or its components as described herein. For example, the operations of the method 1300 may be performed by a network entity as described herein with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include transmitting a first control message indicating an SBFD pattern for SBFD symbols, where the SBFD pattern indicates one or more uplink sub-bands for the SBFD symbols and one or more downlink sub-bands for the SBFD symbols. The operations of 1305 may be performed in accordance with examples as disclosed herein. In some examples, aspects of the operations of 1305 may be performed by an SBFD configuration component 1025 as described herein with reference to FIG. 10.

At 1310, the method may include transmitting a second control message scheduling a set of multiple SSBs via a set of multiple SBFD symbols, where the set of multiple SSBs are associated with a set of multiple SSB bursts. The operations of 1310 may be performed in accordance with examples as disclosed herein. In some examples, aspects of the operations of 1310 may be performed by a scheduling component 1030 as described herein with reference to FIG. 10.

At 1315, the method may include receiving a report indicating one or more SSB bursts, from the set of multiple SSB bursts, that each include one or more SSBs to be measured by a UE, where uplink communications are restricted during one or more first SBFD symbols associated with each of the one or more SSB bursts based on the one or more first SBFD symbols including the one or more SSBs to be measured by the UE. The operations of 1315 may be performed in accordance with examples as disclosed herein. In some examples, aspects of the operations of 1315 may be performed by a feedback component 1035 as described herein with reference to FIG. 10.

The following provides an overview of aspects of the present disclosure:

Aspect 1: A method for wireless communications at a UE, comprising: receiving a first control message indicating a SBFD pattern for SBFD symbols, wherein the SBFD pattern indicates one or more uplink sub-bands for the SBFD symbols and one or more downlink sub-bands for the SBFD symbols; receiving a second control message scheduling a plurality of SSBs via a plurality of SBFD symbols, wherein the plurality of SSBs are associated with a plurality of SSB bursts; and transmitting a report indicating one or more SSB bursts, from the plurality of SSB bursts, that each comprise one or more SSBs to be measured by the UE, wherein uplink communications are restricted during one or more first SBFD symbols associated with each of the one or more SSB bursts based at least in part on the one or more first SBFD symbols comprising the one or more SSBs to be measured by the UE.

Aspect 2: The method of aspect 1, wherein the report comprises a bitmap indicating the one or more SSB bursts from the plurality of SSB bursts.

Aspect 3: The method of any of aspects 1 through 2, wherein the report comprises an indication of a periodicity associated with the one or more SSB bursts.

Aspect 4: The method of any of aspects 1 through 3, wherein the report comprises an indication of a window defined by a slot offset and a duration, and the window comprises the one or more SSB bursts.

Aspect 5: The method of aspect 4, wherein the report further indicates a periodicity associated with the window.

Aspect 6: The method of any of aspects 1 through 5, wherein transmitting the report further comprises: transmitting an indication of the one or more SSBs to be measured by the UE during each of the one or more SSB bursts, wherein restricting uplink communication during the one or more first SBFD symbols is based at least in part on indicating the one or more SSBs to be measured by the UE.

Aspect 7: The method of aspect 6, wherein the report is transmitted via UCI, a CSI report, a MAC-CE, UAI, or any combination thereof.

Aspect 8: The method of any of aspects 6 through 7, wherein the report is transmitted aperiodically, periodically, persistently, semi-persistently, or any combination thereof.

Aspect 9: The method of any of aspects 6 through 8, wherein the report is transmitted based at least in part on a change in the one or more SSBs to be measured by the UE.

Aspect 10: The method of any of aspects 6 through 9, further comprising: initiating a timer based at least in part on transmission of the report, wherein uplink communications are restricted during all SBFD symbols based at least in part on expiration of the timer.

Aspect 11: The method of any of aspects 1 through 10, wherein transmitting the report further comprises: transmitting an indication of one or more second SSBs not to be measured by the UE during each of the one or more SSB bursts, wherein restricting uplink communication during the one or more first SBFD symbols comprising the one or more SSBs to be measured by the UE is based at least in part on indicating the one or more second SSBs not to be measured by the UE.

Aspect 12: The method of aspect 11, wherein the report is transmitted via UCI, a CSI report, a MAC-CE, UAI, or any combination thereof.

Aspect 13: The method of any of aspects 11 through 12, wherein the report is transmitted aperiodically, periodically, persistently, semi-persistently, or any combination thereof.

Aspect 14: The method of any of aspects 11 through 13, wherein the report is transmitted based at least in part on a change in the one or more SSBs to be measured by the UE.

Aspect 15: The method of any of aspects 11 through 14, further comprising: initiating a timer based at least in part on transmission of the report, wherein uplink communications are restricted during all SBFD symbols based at least in part on expiration of the timer.

Aspect 16: The method of any of aspects 1 through 15, further comprising: monitoring for the one or more SSBs via the one or more first SBFD symbols based at least in part on transmitting the report.

Aspect 17: The method of aspect 16, further comprising: canceling uplink transmissions via the one or more first SBFD symbols based at least in part on monitoring for the one or more SSBs via the one or more first SBFD symbols.

Aspect 18: The method of any of aspects 1 through 17, further comprising: receiving a third control message scheduling uplink communications via one or more second SBFD symbols associated with the one or more SSB bursts based at least in part on the one or more second SBFD symbols comprising one or more second SSBs not to be measured by the UE.

Aspect 19: The method of aspect 18, further comprising: canceling measurement on the one or more second SSBs based at least in part on receiving the third control message.

Aspect 20: The method of any of aspects 1 through 19, wherein the UE restricts uplink communications during the one or more first SBFD symbols based at least in part on the report being transmitted a threshold duration prior to the one or more first SBFD symbols.

Aspect 21: The method of any of aspects 1 through 20, further comprising: transmitting a capability message that indicates a capability of the UE to be scheduled with uplink communications via a plurality of SBFD symbols associated with the plurality of SSBs.

Aspect 22: The method of aspect 21, wherein transmitting the capability message comprises: transmitting the capability message indicating a capability of the UE to report the one or more SSBs to be measured by the UE.

Aspect 23: The method of any of aspects 21 through 22, wherein transmitting the capability message comprises: transmitting the capability message indicating a capability of the UE to transmit uplink communications via the plurality of SBFD symbols in accordance with configuration information received from a network entity.

Aspect 24: The method of any of aspects 1 through 23, wherein the one or more SSBs are from a subset of the plurality of SSBs, and the subset of the plurality of SSBs are configured for measurements by the UE.

Aspect 25: The method of any of aspects 1 through 24, wherein the one or more SSBs are received from a primary cell, and uplink transmissions are unrestricted via one or more SBFD symbols associated with one or more secondary cells.

Aspect 26: A method for wireless communications at a network entity, comprising: transmitting a first control message indicating a SBFD pattern for SBFD symbols, wherein the SBFD pattern indicates one or more uplink sub-bands for the SBFD symbols and one or more downlink sub-bands for the SBFD symbols; transmitting a second control message scheduling a plurality of SSBs via a plurality of SBFD symbols, wherein the plurality of SSBs are associated with a plurality of SSB bursts; and receiving a report indicating one or more SSB bursts, from the plurality of SSB bursts, that each comprise one or more SSBs to be measured by a UE, wherein uplink communications are restricted during one or more first SBFD symbols associated with each of the one or more SSB bursts based at least in part on the one or more first SBFD symbols comprising the one or more SSBs to be measured by the UE.

Aspect 27: The method of aspect 26, wherein the report comprises a bitmap indicating the one or more SSB bursts from the plurality of SSB bursts.

Aspect 28: The method of any of aspects 26 through 27, wherein the report comprises an indication of a periodicity associated with the one or more SSB bursts.

Aspect 29: The method of any of aspects 26 through 28, wherein the report comprises an indication of a window defined by a slot offset and a duration, and the window comprises the one or more SSB bursts.

Aspect 30: The method of aspect 29, wherein the report further indicates a periodicity associated with the window.

Aspect 31: The method of any of aspects 26 through 30, wherein receiving the report further comprises: receiving an indication of the one or more SSBs to be measured by the UE during each of the one or more SSB burst, wherein restricting uplink communication during the one or more first SBFD symbols is based at least in part on indicating the one or more SSBs to be measured by the UE.

Aspect 32: The method of aspect 31, wherein the report is received via UCI, a CSI report, a MAC-CE, UAI, or any combination thereof.

Aspect 33: The method of any of aspects 31 through 32, wherein the report is received aperiodically, periodically, persistently, semi-persistently, or any combination thereof.

Aspect 34: The method of any of aspects 31 through 33, wherein the report is received based at least in part on a change in the one or more SSBs to be measured by the UE.

Aspect 35: The method of any of aspects 31 through 34, further comprising: initiating a timer based at least in part on reception of the report, wherein uplink communications are restricted during all SBFD symbols based at least in part on expiration of the timer.

Aspect 36: The method of any of aspects 26 through 35, wherein receiving the report further comprises: receiving an indication of one or more second SSBs not to be measured by the UE during each of the one or more SSB bursts, wherein restricting uplink communication during the one or more first SBFD symbols comprising the one or more SSBs to be measured by the UE is based at least in part on indicating the one or more second SSBs not to be measured by the UE.

Aspect 37: The method of aspect 36, wherein the report is received via UCI, a CSI report, a MAC-CE, UAI, or any combination thereof.

Aspect 38: The method of any of aspects 36 through 37, wherein the report is received aperiodically, periodically, persistently, semi-persistently, or any combination thereof.

Aspect 39: The method of any of aspects 36 through 38, wherein the report is received based at least in part on a change in the one or more SSBs to be measured by the UE.

Aspect 40: The method of any of aspects 36 through 39, further comprising:

initiating a timer based at least in part on reception of the report, wherein uplink communications are restricted during all SBFD symbols based at least in part on expiration of the timer.

Aspect 41: The method of any of aspects 26 through 40, further comprising: refraining from scheduling uplink communications during the one or more first SBFD symbols based at least in part on uplink communications being restricted during the one or more first SBFD symbols.

Aspect 42: The method of any of aspects 26 through 41, further comprising: transmitting a third control message scheduling uplink communications via one or more second SBFD symbols associated with the one or more SSB bursts based at least in part on the one or more second SBFD symbols comprising one or more second SSBs not to be measured by the UE.

Aspect 43: The method of any of aspects 26 through 42, wherein the network entity restricts uplink communications during the one or more first SBFD symbols based at least in part on the report being received a threshold duration prior to the one or more first SBFD symbols.

Aspect 44: The method of any of aspects 26 through 43, further comprising: receiving a capability message that indicates a capability of the UE to be scheduled with uplink communications via a plurality of SBFD symbols associated with the plurality of SSBs.

Aspect 45: The method of aspect 44, wherein receiving the capability message comprises: receiving the capability message indicating a capability of the UE to report the one or more SSBs to be measured by the UE.

Aspect 46: The method of any of aspects 44 through 45, wherein receiving the capability message comprises: receiving the capability message indicating a capability of the UE to transmit uplink communications via the plurality of SBFD symbols in accordance with configuration information transmitted by the network entity.

Aspect 47: The method of any of aspects 26 through 46, wherein the one or more SSBs are from a subset of the plurality of SSBs, and the subset of the plurality of SSBs are configured for measurements by the UE.

Aspect 48: The method of any of aspects 26 through 47, wherein the network entity is a primary cell, and uplink transmissions are unrestricted via one or more SBFD symbols associated with one or more secondary cells.

Aspect 49: A UE for wireless communications, comprising one or more memories storing processor-executable code, and one or more processors coupled with the one or more memories and individually or collectively operable to execute the code to cause the UE to perform a method of any of aspects 1 through 25.

Aspect 50: A UE for wireless communications, comprising at least one means for performing a method of any of aspects 1 through 25.

Aspect 51: A non-transitory computer-readable medium storing code for wireless communications, the code comprising instructions executable by one or more processors to perform a method of any of aspects 1 through 25.

Aspect 52: A network entity for wireless communications, comprising one or more memories storing processor-executable code, and one or more processors coupled with the one or more memories and individually or collectively operable to execute the code to cause the network entity to perform a method of any of aspects 26 through 48.

Aspect 53: A network entity for wireless communications, comprising at least one means for performing a method of any of aspects 26 through 48.

Aspect 54: A non-transitory computer-readable medium storing code for wireless communications, the code comprising instructions executable by one or more processors to perform a method of any of aspects 26 through 48.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first control message indicating a sub-band full-duplex (SBFD) pattern for SBFD symbols, wherein the SBFD pattern indicates one or more uplink sub-bands for the SBFD symbols and one or more downlink sub-bands for the SBFD symbols;
receive a second control message scheduling a plurality of synchronization signal blocks (SSBs) via a plurality of SBFD symbols, wherein the plurality of SSBs are associated with a plurality of SSB bursts; and
transmit a report indicating one or more SSB bursts, from the plurality of SSB bursts, that each comprise one or more SSBs to be measured by the UE, wherein uplink communications are restricted during one or more first SBFD symbols associated with each of the one or more SSB bursts based at least in part on the one or more first SBFD symbols comprising the one or more SSBs to be measured by the UE.

2. The UE of claim 1, wherein the report comprises a bitmap indicating the one or more SSB bursts from the plurality of SSB bursts, an indication of a periodicity and a time offset associated with the one or more SSB bursts, an indication of a window defined by a slot offset and a duration, wherein the window comprises the one or more SSB bursts, an indication of a periodicity associated with the window, or any combination thereof.

3. The UE of claim 1, wherein, to transmit the report, the one or more processors are individually or collectively further operable to execute the code to cause the UE to:
transmit an indication of the one or more SSBs to be measured by the UE during each of the one or more SSB bursts, wherein restricting uplink communication during the one or more first SBFD symbols is based at least in part on indicating the one or more SSBs to be measured by the UE.

4. The UE of claim 1, wherein, to transmit the report, the one or more processors are individually or collectively further operable to execute the code to cause the UE to:
transmit an indication of one or more second SSBs not to be measured by the UE during each of the one or more SSB bursts, wherein restricting uplink communication during the one or more first SBFD symbols comprising the one or more SSBs to be measured by the UE is based at least in part on indicating the one or more second SSBs not to be measured by the UE.

5. The UE of claim 1, wherein the report is transmitted via uplink control information (UCI), a channel state information (CSI) report, a medium access control (MAC)-control element (MAC-CE), UE assistance information (UAI), or any combination thereof.

6. The UE of claim 1, wherein the report is transmitted aperiodically, periodically, persistently, semi-persistently, by event triggering, or any combination thereof.

7. The UE of claim 1, wherein the report is transmitted based at least in part on a change in the one or more SSBs to be measured by the UE.

8. The UE of claim 1, wherein the one or more processors are individually or collectively further operable to execute the code to cause the UE to:
initiate a timer based at least in part on transmission of the report, wherein uplink communications are restricted during all SBFD symbols based at least in part on expiration of the timer.

9. The UE of claim 1, wherein the one or more processors are individually or collectively further operable to execute the code to cause the UE to:
monitor for the one or more SSBs via the one or more first SBFD symbols based at least in part on transmitting the report.

10. The UE of claim 9, wherein the one or more processors are individually or collectively further operable to execute the code to cause the UE to:
cancel uplink transmissions via the one or more first SBFD symbols based at least in part on monitoring for the one or more SSBs via the one or more first SBFD symbols.

11. The UE of claim 1, wherein the one or more processors are individually or collectively further operable to execute the code to cause the UE to:
receive a third control message scheduling uplink communications via one or more second SBFD symbols associated with the one or more SSB bursts based at least in part on the one or more second SBFD symbols comprising one or more second SSBs not to be measured by the UE.

12. The UE of claim 11, wherein the one or more processors are individually or collectively further operable to execute the code to cause the UE to:
cancel measurement on the one or more second SSBs based at least in part on receiving the third control message.

13. The UE of claim 1, wherein the UE restricts uplink communications during the one or more first SBFD symbols based at least in part on the report being transmitted a threshold duration prior to the one or more first SBFD symbols.

14. The UE of claim 1, wherein the one or more processors are individually or collectively further operable to execute the code to cause the UE to:
transmit a capability message that indicates a capability of the UE to be scheduled with uplink communications via a plurality of SBFD symbols associated with the plurality of SSBs.

15. The UE of claim 14, wherein, to transmit the capability message, the one or more processors are individually or collectively operable to execute the code to cause the UE to:
transmit the capability message indicating a capability of the UE to report the one or more SSBs to be measured by the UE.

16. The UE of claim 14, wherein, to transmit the capability message, the one or more processors are individually or collectively operable to execute the code to cause the UE to:
transmit the capability message indicating a capability of the UE to transmit uplink communications via the plurality of SBFD symbols in accordance with configuration information received from a network entity.

17. The UE of claim 1, wherein the one or more SSBs are from a subset of the plurality of SSBs, and wherein the subset of the plurality of SSBs are configured for measurements by the UE.

18. The UE of claim 1, wherein the one or more SSBs are received from a primary cell, and wherein uplink transmissions are unrestricted via one or more SBFD symbols associated with one or more secondary cells.

19. A method for wireless communications at a user equipment (UE), comprising:
receiving a first control message indicating a sub-band full-duplex (SBFD) pattern for SBFD symbols, wherein the SBFD pattern indicates one or more uplink sub-bands for the SBFD symbols and one or more downlink sub-bands for the SBFD symbols;
receiving a second control message scheduling a plurality of synchronization signal blocks (SSBs) via a plurality of SBFD symbols, wherein the plurality of SSBs are associated with a plurality of SSB bursts; and
transmitting a report indicating one or more SSB bursts, from the plurality of SSB bursts, that each comprise one or more SSBs to be measured by the UE, wherein uplink communications are restricted during one or more first SBFD symbols associated with each of the one or more SSB bursts based at least in part on the one or more first SBFD symbols comprising the one or more SSBs to be measured by the UE.

20. A user equipment (UE) for wireless communications, comprising:
means for receiving a first control message indicating a sub-band full-duplex (SBFD) pattern for SBFD symbols, wherein the SBFD pattern indicates one or more uplink sub-bands for the SBFD symbols and one or more downlink sub-bands for the SBFD symbols;
means for receiving a second control message scheduling a plurality of synchronization signal blocks (SSBs) via a plurality of SBFD symbols, wherein the plurality of SSBs are associated with a plurality of SSB bursts; and
means for transmitting a report indicating one or more SSB bursts, from the plurality of SSB bursts, that each comprise one or more SSBs to be measured by the UE, wherein uplink communications are restricted during one or more first SBFD symbols associated with each of the one or more SSB bursts based at least in part on the one or more first SBFD symbols comprising the one or more SSBs to be measured by the UE.
